(19) United States
(12) Patent Application Publication
(10) Pub. No.: US 2025/0372119 A1
(43) Pub. Date: Dec. 4, 2025

(54) CAPTURING AND PROCESSING AUDIO SIGNALS

(71) Applicant: ORCAM TECHNOLOGIES LTD., Jerusalem (IL)

(72) Inventors: Roi NATHAN, Jerusalem (IL); Tal ROSENWEIN, Herzliya (IL); Oren TADMOR, Mevaseret Tsion (IL); Doron WEIZMAN, Modiin-Maccabim-Reut (IL); Ofer FEDEROVSKY, Modiin-Maccabim-Reut (IL); Asher BEN SHITRIT, Tel Aviv (IL); David LEVIN, Jerusalem (IL); Amnon SHASHUA, Mevaseret Tsion (IL); Yonatan WEXLER, Jerusalem (IL)

(21) Appl. No.: 19/298,824

(22) Filed: Aug. 13, 2025

Related U.S. Application Data
(63) Continuation of application No. PCT/IL2024/050024, filed on Jan. 8, 2024.
(60) Provisional application No. 63/445,308, filed on Feb. 14, 2023.

(51) Int. Cl. G10L 25/84; H04R 1/08; H04R 25/00

(52) U.S. Cl. CPC G10L 25/84; H04R 25/00; H04R 1/08; H04R 2225/43

(57) ABSTRACT

A system, product and method comprising: capturing, by two or more microphones of a separate device physically separate from a hearable device of a user, a noisy audio signal from an environment of the user, wherein a plurality of people is present in the environment, the hearable device is used for providing audio output to the user; processing the noisy audio signal, thereby obtaining an enhanced audio signal, said processing comprises applying speech separation on the noisy audio signal to obtain a separate speech segment of a person of the plurality of people, wherein the speech separation utilizes an acoustic fingerprint of the person for extracting the separate speech segment of the person; and outputting the enhanced audio signal to the user via the at least one hearable device.

### CROSS-REFERENCE TO RELATED APPLICATION

This application is a continuation of International Patent Application No. PCT/IL2024/050024, filed Jan. 8, 2024, which claims the benefit of Provisional Patent Application No. 63/445,308, entitled “Hearing Aid System”, filed Feb. 14, 2023, each of which are hereby incorporated by reference in their entirety without giving rise to disavowment.

### TECHNICAL FIELD

The present disclosure relates to processing audio signals in general, and to capturing and processing audio signals from a noisy environment of a user, in particular.

### BACKGROUND

A conventional hearing aid is a device designed to improve hearing by making sound audible to a person with hearing loss or hearing degradation. Hearing aids are used for a variety of pathologies including sensorineural hearing loss, conductive hearing loss, and single-sided deafness. Conventional hearing aids are classified as medical devices in most countries, and regulated by the respective regulations. Hearing aid candidacy is traditionally determined by a Doctor of Audiology, or a certified hearing specialist, who will also fit the device based on the nature and degree of the hearing loss being treated.

Hearables, on the other hand, are over-the-counter ear-worn devices that can be obtained without a prescription, and without meeting specialists. Hearables may typically comprise speakers to convert analog signals to sound, a Bluetooth™ Integrated Circuit (IC) to communicate with other devices, sensors such as biometric sensors, microphones, or the like.

U.S. Pat. No. 10,856,071B2 discloses a system and method for improving hearing. The system includes a microphone array that includes an enclosure, a plurality of beamformer microphones and an electronic processing circuitry to provide enhanced audio signals to a user by using information obtained on the position and orientation of the user. The system is in the form of a smartphone having a retractable piece having the beamformer microphones mounted thereon.

### BRIEF SUMMARY

One exemplary embodiment of the disclosed subject matter is a method performed in an environment of a user, wherein a plurality of people is present in the environment, the user having at least one hearable device used for providing audio output to the user, the method comprising: capturing, by two or more microphones of at least one separate device physically separate from the at least one hearable device, a noisy audio signal from the environment of the user; processing the noisy audio signal, thereby obtaining an enhanced audio signal, said processing comprises applying speech separation on the noisy audio signal to obtain a separate speech segment of a person of the plurality of people, wherein the speech separation utilizes an acoustic fingerprint of the person for extracting the separate speech segment of the person; and outputting the enhanced audio signal to the user via the at least one hearable device.

Optionally, the two or more microphones of the at least one separate device comprise an array of three microphones, wherein the three microphones are positioned as vertices of a substantially equilateral triangle, whereby a distance between any two microphones of the three microphones is substantially identical.

Optionally, the distance is above a minimal threshold.

Optionally, the two or more microphones of the at least one separate device comprise an array of three microphones, wherein the three microphones are positioned as vertices of a substantial isosceles triangle, whereby a distance between a first microphone and each of a second and third microphones is substantially identical.

Optionally, the two or more microphones of the at least one separate device comprise an array of at least three microphones, wherein the at least three microphones maintain a line of sight with each other.

Optionally, the two or more microphones of the at least one separate device comprise an array of at least four microphones, wherein the at least four microphones are positioned in two or more planes, thereby enabling to obtain three degrees of freedom.

Optionally, one or more second microphones of the at least one hearable device are configured to capture a second noisy audio signal from the environment of the user, the second noisy audio signal at least partially corresponding to the noisy audio signal, wherein, using the second noisy audio signal, the at least one hearable device can operate to process and output audio irrespective of a connectivity between the at least one hearable device and the at least one separate device, whereby operation of the at least one hearable device is enhanced when having the connectivity with the at least one separate device, but is not dependent thereon.

Optionally, said processing the noisy audio signal is performed, at least partially, at the at least one separate device.

Optionally, the method comprises communicating the enhanced audio signal from the at least one separate device to the at least one hearable device, wherein said communicating is performed prior to said outputting.

Optionally, the at least one separate device comprises at least one of: a case of the at least one hearable device, a dongle that is configured to be coupled to a mobile device of the user, and the mobile device of the user.

Optionally, the two or more microphones are positioned on the dongle.

Optionally, the at least one separate device comprises at least two separate devices selected from: the case, the dongle, and the mobile device of the user, wherein said processing comprises communicating captured audio signals between the at least two separate devices.

Optionally, the at least one separate device comprises the case, the dongle, and the mobile device, wherein the case, the dongle, and the mobile device comprise respective sets of one or more microphones, wherein said processing comprises communicating audio signals captured by the respective sets of one or more microphones between the case, the dongle, and the mobile device.

Optionally, said processing is performed partially on at least one separate device, and partially on the at least one hearable device.

Optionally, the method comprises selecting how to distribute said processing between the at least one hearable device and the at least one separate device.

Optionally, said selecting is performed automatically based on at least one of: user instructions, a complexity of a conversation of the user in the environment, and a selected setting.

Optionally, the at least hearable device is operatively coupled, directly or indirectly, to a mobile device, wherein said selecting comprising selecting how to distribute the processing between the at least one hearable device and the mobile device.

Another exemplary embodiment of the disclosed subject matter is a system comprising: at least one hearable device used for providing audio output to a user; and at least one separate device that is physically separate from the at least one hearable device, the at least one separate device comprising two or more microphones, wherein the at least one separate device is configured to perform: capturing, by the two or more microphones of the at least one separate device, a noisy audio signal from an environment of the user, wherein a plurality of people is located in the environment; processing the noisy audio signal, thereby obtaining an enhanced audio signal, said processing comprises applying speech separation on the noisy audio signal to obtain a separate speech segment of a person of the plurality of people, wherein the speech separation utilizes an acoustic fingerprint of the person for extracting the separate speech segment of the person; and communicating the separate speech segment to the at least one hearable device, whereby enabling the at least one hearable device to output the enhanced audio signal to the user.

Yet another exemplary embodiment of the disclosed subject matter is a computer program product comprising a non-transitory computer readable storage medium retaining program instructions, which program instructions when read by a processor, cause the processor to perform the steps of: capturing, by two or more microphones of at least one separate device physically separate from at least one hearable device, a noisy audio signal from an environment of a user, wherein a plurality of people is present in the environment, the user using the at least one hearable device for providing audio output to the user; processing the noisy audio signal, thereby obtaining an enhanced audio signal, said processing comprises applying speech separation on the noisy audio signal to obtain a separate speech segment of a person of the plurality of people, wherein the speech separation utilizes an acoustic fingerprint of the person for extracting the separate speech segment of the person; and outputting the enhanced audio signal to the user via the at least one hearable device.

Yet another exemplary embodiment of the disclosed subject matter is an apparatus comprising a processor and coupled memory, the processor being adapted to perform the steps of: capturing, by two or more microphones of at least one separate device physically separate from at least one hearable device, a noisy audio signal from an environment of a user, wherein a plurality of people is present in the environment, the user using the at least one hearable device for providing audio output to the user; processing the noisy audio signal, thereby obtaining an enhanced audio signal, said processing comprises applying speech separation on the noisy audio signal to obtain a separate speech segment of a person of the plurality of people, wherein the speech separation utilizes an acoustic fingerprint of the person for extracting the separate speech segment of the person; and outputting the enhanced audio signal to the user via the at least one hearable device.

One exemplary embodiment of the disclosed subject matter is a method comprising: obtaining during a first timeframe, by at least one hearable device used by a user and configured for providing audio output to the user, a first noisy audio signal from an environment of the user, the first noisy audio signal comprising a first speech segment of the user, the environment of the user comprising at least a second entity other than the user; processing the first noisy audio signal at the at least one hearable device, said processing comprises applying a first speech separation on the first noisy audio signal to extract the first speech segment of the user, whereby said processing the first noisy audio signal incurs a first delay; obtaining a second noisy audio signal during a second timeframe, the second timeframe at least partially overlaps with the first timeframe; processing the second noisy audio signal, said processing comprises applying a second speech separation on the second noisy audio signal to extract a second speech segment emitted by the second person, whereby said processing the second noisy audio signal incurs a second delay greater than the first delay; and based on the first and second speech segments, outputting an enhanced audio signal to the user via the at least one hearable device.

Optionally, said obtaining the second noisy audio signal is performed at a separate device that is physically separate from the at least one hearable device, wherein said processing is performed at the separate device.

Optionally, the method comprises communicating the second speech segment from the separate device to the at least one hearable device, whereby said communicating and said processing at the separate device incur the second delay.

Optionally, said obtaining the second noisy audio signal is performed at the at least one hearable device, wherein the second noisy audio signal comprises the first noisy audio signal.

Optionally, the first speech separation utilizes a first software module, and the second speech separation utilizes a second software module, wherein the first software module is configured to utilize less computational resources than the second software module.

Optionally, the first software module is configured to extract the first speech segment of the user based on a Signal-to-Noise Ratio (SNR) of the user in the first noisy audio signal.

Optionally, said obtaining the first noisy audio signal comprises capturing at least a portion of the first noisy audio signal by at least one microphone of the at least one hearable device.

Optionally, said capturing is configured to be performed by at least one of: a first microphone located at a left side of the user, and a second microphone located at a right side of the user, wherein said processing the first noisy audio signal is based on a-priori knowledge of at least one relative location of the first or second microphones with respect to the user.

Optionally, the at least one hearable device comprises an array of at least first and second microphones, wherein said processing the first noisy audio signal is based on a-priori knowledge of at least one relative location of the first microphone with respect to the second microphone.

Optionally, said obtaining the second noisy audio signal comprises capturing at least a portion of the second noisy audio signal by at least one microphone of the separate device.

Optionally, said outputting comprises generating the enhanced audio signal based on a time offset between the first and second noisy audio signals.

Optionally, said obtaining the second noisy audio signal comprises obtaining the first noisy audio signal from the at least one hearable device, wherein the second noisy audio signal is the first noisy audio signal.

Optionally, said obtaining the second noisy audio signal comprises receiving the second noisy audio signal from the at least one hearable device, wherein the second noisy audio signal is captured by a microphone of the at least one hearable device.

Optionally, the separate device comprises at least one of: a mobile device of the user, a dongle that is coupled to the mobile device, and a case of the at least one hearable device.

Optionally, the at least one hearable device comprises speakers and is configured to output the enhanced audio signal using the speakers and independently of any speaker of the separate device.

Optionally, the second speech separation is configured to extract the second speech segment from the second noisy audio signal based on an acoustic fingerprint of the second person.

Optionally, the first speech separation is performed without using an acoustic fingerprint of any entity, whereby computational resources required for the first speech separation are lesser than computational resources required for the second speech separation.

Optionally, the second speech separation is configured to identify, after utilizing the acoustic fingerprint of the second person for executing a first speech separation module, a direction of arrival of a speech of the second person, wherein the second speech separation is configured to execute a second speech separation module that utilizes the direction of arrival and does not utilize the acoustic fingerprint, the second speech separation module utilizing less resources than the first speech separation module.

Optionally, the at least one of the first and second speech separation is performed based on a speech separation module that does not utilize any acoustic fingerprint.

Optionally, the second speech separation is configured to extract from the second noisy audio signal a speech segment of the user and the second speech segment of the second person, wherein the separate device is not configured to communicate the speech segment of the user to the at least one hearable device.

Optionally, the second speech separation is configured to extract from the second noisy audio signal a speech segment of the user and the second speech segment of the second person, wherein the separate device is configured to communicate the speech segment of the user to the at least one hearable device, and the at least one hearable device is configured to remove the speech segment of the user from the enhanced audio signal.

Optionally, the at least one hearable device is configured to identify that the speech segment of the user belongs to the user based on a Signal-to-Noise Ratio (SNR) of the speech segment in the first noisy audio signal.

Optionally, the method comprises determining a direction of arrival of the first speech segment based on a default position of the at least one hearable device relative to the user.

Optionally, said determining the direction of arrival is performed using at least one of: a beamforming receiver array, a parametric model, a Time Difference of Arrival (TDoA) model, a data-driven model, and a learnable probabilistic model.

Optionally, the at least one hearable device comprises a left-ear module and a right-ear module configured to be mounted on a left ear and a right ear of the user, respectively, the left-ear module comprising a left microphone and a left speaker, the right-ear module comprising a right microphone and a right speaker, wherein said first speech separation is performed based on: determining that a direction of arrival of audio captured by the left microphone matches an approximate relative location of a mouth of the user with respect to the left ear of the user, and determining that a direction of arrival of audio captured by the right microphone matches an approximate relative location of the mouth of the user with respect to the right ear of the user.

Optionally, the second timeframe is identical to the first timeframe.

Optionally, the second person speaks at a first timepoint, wherein the user speaks at a second timepoint that is later than the first timepoint, wherein the enhanced audio signal is provided to the user at a third timepoint that is later than the second timepoint, whereby a time lag between the first timepoint and the third timepoint is longer than a time lag between the second timepoint and the third timepoint.

Optionally, the at least one hearable device is configured to perform at least one of: Active Noise Cancellation (ANC) and passive noise cancellation, in order to reduce a collision between sounds in the environment and a delayed version of the sounds in the enhanced audio signal.

Optionally, at least part of the first delay is incurred from communicating the first noisy audio signal from one or more microphones of the at least one hearable device to a processing unit of the at least one hearable device.

Optionally, the at least one hearable device comprises at least one respective earbud.

Another exemplary embodiment of the disclosed subject matter is a system comprising: at least one hearable device configured for providing audio output to a user; and at least one separate device that is physically separate from the at least one hearable device, wherein the at least one hearable device is configured to: obtain during a first timeframe, a first noisy audio signal from an environment of the user, the first noisy audio signal comprising a first speech segment of the user, the environment of the user comprising at least a second entity other than the user; and process the first noisy audio signal, said process comprises applying a first speech separation on the first noisy audio signal to extract the first speech segment of the user, whereby said process the first noisy audio signal incurs a first delay; wherein the at least one separate device is configured to: obtain a second noisy audio signal during a second timeframe, the second timeframe at least partially overlaps with the first timeframe; and process the second noisy audio signal, said process comprises applying a second speech separation on the second noisy audio signal to extract a second speech segment emitted by the second person, whereby said process the second noisy audio signal incurs a second delay greater than the first delay, wherein the at least one hearable device is configured to output an enhanced audio signal to the user via the at least one hearable device based on the first and second speech segments.

Yet another exemplary embodiment of the disclosed subject matter is a computer program product comprising a non-transitory computer readable storage medium retaining program instructions, which program instructions when read by a processor, cause the processor to perform the steps of: obtaining during a first timeframe, by at least one hearable device used by a user and configured for providing audio output to the user, a first noisy audio signal from an environment of the user, the first noisy audio signal comprising a first speech segment of the user, the environment of the user comprising at least a second entity other than the user; processing the first noisy audio signal at the at least one hearable device, said processing comprises applying a first speech separation on the first noisy audio signal to extract the first speech segment of the user, whereby said processing the first noisy audio signal incurs a first delay; obtaining a second noisy audio signal during a second timeframe, the second timeframe at least partially overlaps with the first timeframe; processing the second noisy audio signal, said processing comprises applying a second speech separation on the second noisy audio signal to extract a second speech segment emitted by the second person, whereby said processing the second noisy audio signal incurs a second delay greater than the first delay; and based on the first and second speech segments, outputting an enhanced audio signal to the user via the at least one hearable device.

Yet another exemplary embodiment of the disclosed subject matter is an apparatus comprising a processor and coupled memory, the processor being adapted to perform the steps of: obtaining during a first timeframe, by at least one hearable device used by a user and configured for providing audio output to the user, a first noisy audio signal from an environment of the user, the first noisy audio signal comprising a first speech segment of the user, the environment of the user comprising at least a second entity other than the user; processing the first noisy audio signal at the at least one hearable device, said processing comprises applying a first speech separation on the first noisy audio signal to extract the first speech segment of the user, whereby said processing the first noisy audio signal incurs a first delay; obtaining a second noisy audio signal during a second timeframe, the second timeframe at least partially overlaps with the first timeframe; processing the second noisy audio signal, said processing comprises applying a second speech separation on the second noisy audio signal to extract a second speech segment emitted by the second person, whereby said processing the second noisy audio signal incurs a second delay greater than the first delay; and based on the first and second speech segments, outputting an enhanced audio signal to the user via the at least one hearable device.

One exemplary embodiment of the disclosed subject matter is a method performed in an environment of a user, the user having at least one hearable device used for providing audio output to the user, the method comprising: computing a complexity score of a conversation in which the user participates; selecting a computation modality for the conversation based on the complexity score, thereby obtaining a selected computation modality; capturing a noisy audio signal from the environment; processing the noisy audio signal according to the selected computation modality, whereby generating an enhanced audio signal; and outputting the enhanced audio signal to the user via the at least one hearable device.

Optionally, said selecting is performed by comparing the complexity score with a complexity threshold, wherein the selection is made so that: responsive to the complexity score of the conversation being lesser than the complexity threshold, a first speech separation is selected to be performed on the noisy audio signal, the first speech separation is expected to result with a first delay between said capturing and said outputting; and responsive to the complexity score of the conversation exceeding the complexity threshold, a second speech separation is selected to be performed on the noisy audio signal, the second speech separation is expected to result with a second delay between said capturing and said outputting, the second delay is greater than the first delay.

Optionally, the second speech separation utilizes more computational resources than the first speech separation.

Optionally, the second speech separation is configured to separate speech based on acoustic fingerprints of participants participating in the conversation, wherein the first speech separation does not utilize any acoustic fingerprint for speech separation.

Optionally, the first speech separation is configured to separate speech based on direction of arrival calculations of the participants, wherein the second speech separation is configured to separate speech based on acoustic fingerprints of participants participating in the conversation.

Optionally, the first speech separation is configured to be performed at a first device, and the second separation is configured to be performed at a second device, wherein the first and second device are selected from: a mobile device of the user, a dongle that is configured to be coupled to the mobile device of the user, a case for storing the at least one hearable device, and the at least one hearable device.

Optionally, said selecting is performed by comparing the complexity score with a complexity threshold, wherein the selection is made so that: responsive to the complexity score of the conversation being lesser than the complexity threshold, said processing is selected to be performed by the at least one hearable device; and responsive to the complexity score of the conversation exceeding the complexity threshold, said processing is selected to be performed by a separate device that is physically separate from the at least one hearable device, wherein the separate device comprises at least one of: a mobile device of the user, a dongle that is configured to be coupled to the mobile device of the user, and a case for storing the at least one hearable device.

Optionally, subsequently to said outputting, computing a second complexity score of the conversation in which the user participates, the second complexity score different from the first complexity score; selecting a second computation modality for the conversation based on the second complexity score, thereby obtaining a second selected computation modality, wherein the second selected computation modality is different from the selected computation modality; capturing a second noisy audio signal from the environment; processing the second noisy audio signal according to the second selected computation modality, whereby generating a second enhanced audio signal; and outputting the second enhanced audio signal to the user via the at least one hearable device.

Optionally, the selected computation modality comprises utilizing a first speech separation that is expected to result with a first delay, and the second selected computation modality comprises utilizing a second speech separation that is expected to result with a second delay greater than the first delay.

Optionally, the selected computation modality comprises performing said processing the noisy audio signal by the at least one hearable device, and the second selected computation modality comprises performing said processing the second noisy audio signal by a separate device that is physically separate from the at least one hearable device, wherein the separate device comprises at least one of: a mobile device of the user, a dongle that is configured to be coupled to the mobile device of the user, and a case for storing the at least one hearable device.

Optionally, said computing the complexity score of the conversation is performed based on at least one of: a Signal-to-Noise Ratio (SNR) of the conversation, and an SNR of an overall sound in the environment.

Optionally, said computing the complexity score of the conversation is performed based on at least one of: an intelligibility level of the conversation, and a confidence score of a speech separation module, distance from the target speaker.

Optionally, said computing the complexity score of the conversation is performed based on a number of participants in the conversation.

Optionally, said computing the complexity score of the conversation is performed during short, mid, or long timeframes.

Optionally, the complexity score of the conversation depends on an overlap between audio frequencies of the conversation and audio frequencies of a background noise in the environment.

Optionally, the complexity score of the conversation depends on a frequency range of background noise in the environment.

Optionally, the complexity score of the conversation depends on a monotonic metric of background noise in the environment, the monotonic metric measuring a monotonicity level of the background noise.

Optionally, the complexity score of the conversation depends on a similarity measurement of two voices in the environment, wherein the two voices are emitted by two separate entities.

Optionally, the complexity score of the conversation depends on a similarity measurement between a first acoustic fingerprint of a first entity and a second acoustic fingerprint of a second entity, wherein the first and second entities participate in the conversation.

Optionally, said selecting the computation modality comprises selecting to apply speech separation on the noisy audio signal at a mobile device of the user.

Optionally, said selecting the computation modality comprises selecting to apply speech separation using a processor embedded in a case of the at least one hearable device, wherein the at least one hearable device is configured to be stored within the case.

Optionally, said selecting the computation modality comprises selecting to apply speech separation using a processor embedded in the at least one hearable device.

Optionally, the at least one hearable device comprises two earbuds.

Optionally, the method comprises selecting a model to be used in processing the conversation based on the complexity score, wherein the model is selected from a set of models that are applicable to the selected computation modality; and wherein said processing the noisy audio signal is performed according to the selected computation modality and using the selected model.

Another exemplary embodiment of the disclosed subject matter is a system comprising a processor and coupled memory, the processor being adapted to: compute a complexity score of a conversation in which a user participates, wherein an environment of the user comprises at least one hearable device configured for providing audio output to the user; select a computation modality for the conversation based on the complexity score, thereby obtaining a selected computation modality; capture a noisy audio signal from the environment; process the noisy audio signal according to the selected computation modality, whereby generating an enhanced audio signal; and output the enhanced audio signal to the user via the at least one hearable device.

Yet another exemplary embodiment of the disclosed subject matter is an apparatus comprising a processor and coupled memory, the processor being adapted to: compute a complexity score of a conversation in which a user participates, wherein an environment of the user comprises at least one hearable device configured for providing audio output to the user; select a computation modality for the conversation based on the complexity score, thereby obtaining a selected computation modality; capture a noisy audio signal from the environment; process the noisy audio signal according to the selected computation modality, whereby generating an enhanced audio signal; and output the enhanced audio signal to the user via the at least one hearable device.

Yet another exemplary embodiment of the disclosed subject matter is a computer program product comprising a non-transitory computer readable storage medium retaining program instructions, which program instructions when read by a processor, cause the processor to: compute a complexity score of a conversation in which a user participates, wherein an environment of the user comprises at least one hearable device configured for providing audio output to the user; select a computation modality for the conversation based on the complexity score, thereby obtaining a selected computation modality; capture a noisy audio signal from the environment; process the noisy audio signal according to the selected computation modality, whereby generating an enhanced audio signal; and output the enhanced audio signal to the user via the at least one hearable device.

One exemplary embodiment of the disclosed subject matter is a method performed in an environment of a user, the user using at least one hearable device configured for providing audio output to the user, the at least one hearable device comprising a first hearing module and a second hearing module, the environment comprising an array of two or more microphones, the environment comprising a target person different from the user, wherein the target person is in closer proximity to the first hearing module than to the second hearing module, the method comprising: capturing, by the array of two or more microphones, a noisy audio signal from the environment, the noisy audio signal comprising a speech segment of the target person; based on the noisy audio signal, generating a stereo audio signal configured to simulate a directionality of sound as if the stereo audio signal is provided to the user from the target person, wherein said generating comprises generating a first audio signal for the first hearing module and generating a second audio signal for the second hearing module, wherein said generating comprises injecting a delay into the second audio signal without injecting the delay into the first audio signal, wherein the first and second audio signals represent the speech segment; and outputting to the user, via the at least one hearable device, the stereo audio signal, wherein said outputting causes the first audio signal to reach the first hearing module before the second audio signal reaches the second hearing module, thereby simulating the directionality of sound.

Optionally, said generating is performed based on a first angle of the user with respect to the array of two or more microphones, and based on a second angle of the target person with respect to the array of two or more microphones.

Optionally, the method comprises processing the noisy audio signal at a single processing unit, wherein the single processing unit is embedded within the at least one hearable device or within at least one separate device that is physically separate from the at least one hearable device.

Optionally, the separate device comprises at least one of: a mobile device of the user, a dongle that is configured to be coupled to the mobile device of the user, and a case for storing the at least one hearable device.

Optionally, said generating is performed by the at least one hearable device or by the single processing unit.

Optionally, said processing comprises applying a speech separation on the noisy audio signal.

Optionally, the array of two or more microphones is mounted on the first and second hearing modules, and wherein said processing comprises communicating the noisy audio signal between the first and second hearing modules.

Optionally, the array of two or more microphones is mounted on a separate device that is physically separate from the at least one hearable device, wherein said processing comprises determining a direction of arrival of the noisy audio signal at the separate device.

Optionally, the first hearing module is a left-ear earbud having embedded thereon the first microphone and a left-ear speaker, the second hearing module is a right-ear earbud having embedded thereon the second microphone and a right-ear speaker, wherein the left-ear earbud is configured to be mounted on a left ear of the user, wherein the right-ear earbud is configured to be mounted on a right ear of the user.

Optionally, said processing comprises: determining a direction of arrival of a first noisy audio signal captured by the first microphone according to a relative location of a mouth of the user with respect to the left ear of the user, and determining a direction of arrival of a second noisy audio signal captured by the second microphone according to a relative location of the mouth of the user with respect to the right ear of the user.

Optionally, a first set of a plurality of microphones is embedded in the left-ear earbud, and a second set of a plurality of microphones is embedded in the right-ear earbud.

Optionally, the delay is determined based on at least one of: a distance between the user and the target person, an angle between the user and the target person, and a speed of sound.

Another exemplary embodiment of the disclosed subject matter is a system comprising a processor and coupled memory, the processor being adapted to: capture, by an array of two or more microphones, a noisy audio signal from an environment of a user, the user using at least one hearable device configured for providing audio output to the user, the at least one hearable device comprising a first hearing module and a second hearing module, the environment comprising the array of two or more microphones, the environment comprising a target person different from the user, wherein the target person is in closer proximity to the first hearing module than to the second hearing module, the noisy audio signal comprising a speech segment of the target person; based on the noisy audio signal, generate a stereo audio signal configured to simulate a directionality of sound as if the stereo audio signal is provided to the user from the target person, wherein said generate comprises generating a first audio signal for the first hearing module and generating a second audio signal for the second hearing module, wherein said generate comprises injecting a delay into the second audio signal without injecting the delay into the first audio signal, wherein the first and second audio signals represent the speech segment; and output to the user, via the at least one hearable device, the stereo audio signal, wherein said output causes the first audio signal to reach the first hearing module before the second audio signal reaches the second hearing module, thereby simulating the directionality of sound.

Yet another exemplary embodiment of the disclosed subject matter is an apparatus comprising a processor and coupled memory, the processor being adapted to: capture, by an array of two or more microphones, a noisy audio signal from an environment of a user, the user using at least one hearable device configured for providing audio output to the user, the at least one hearable device comprising a first hearing module and a second hearing module, the environment comprising the array of two or more microphones, the environment comprising a target person different from the user, wherein the target person is in closer proximity to the first hearing module than to the second hearing module, the noisy audio signal comprising a speech segment of the target person; based on the noisy audio signal, generate a stereo audio signal configured to simulate a directionality of sound as if the stereo audio signal is provided to the user from the target person, wherein said generate comprises generating a first audio signal for the first hearing module and generating a second audio signal for the second hearing module, wherein said generate comprises injecting a delay into the second audio signal without injecting the delay into the first audio signal, wherein the first and second audio signals represent the speech segment; and output to the user, via the at least one hearable device, the stereo audio signal, wherein said output causes the first audio signal to reach the first hearing module before the second audio signal reaches the second hearing module, thereby simulating the directionality of sound.

Yet another exemplary embodiment of the disclosed subject matter is a computer program product comprising a non-transitory computer readable storage medium retaining program instructions, which program instructions when read by a processor, cause the processor to: capture, by an array of two or more microphones, a noisy audio signal from an environment of a user, the user using at least one hearable device configured for providing audio output to the user, the at least one hearable device comprising a first hearing module and a second hearing module, the environment comprising the array of two or more microphones, the environment comprising a target person different from the user, wherein the target person is in closer proximity to the first hearing module than to the second hearing module, the noisy audio signal comprising a speech segment of the target person; based on the noisy audio signal, generate a stereo audio signal configured to simulate a directionality of sound as if the stereo audio signal is provided to the user from the target person, wherein said generate comprises generating a first audio signal for the first hearing module and generating a second audio signal for the second hearing module, wherein said generate comprises injecting a delay into the second audio signal without injecting the delay into the first audio signal, wherein the first and second audio signals represent the speech segment; and output to the user, via the at least one hearable device, the stereo audio signal, wherein said output causes the first audio signal to reach the first hearing module before the second audio signal reaches the second hearing module, thereby simulating the directionality of sound.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 shows an exemplary flowchart diagram of a method, in accordance with some exemplary embodiments of the disclosed subject matter;

FIG. 2 shows an exemplary flowchart diagram of a method, in accordance with some exemplary embodiments of the disclosed subject matter;

FIG. 3 shows an exemplary flowchart diagram of a method, in accordance with some exemplary embodiments of the disclosed subject matter;

FIG. 4 shows an exemplary flowchart diagram of a method, in accordance with some exemplary embodiments of the disclosed subject matter;

FIG. 5 shows a schematic illustration of an exemplary environment in which the disclosed subject matter may be utilized, in accordance with some exemplary embodiments of the disclosed subject matter;

FIG. 6A shows a schematic illustration of an exemplary environment in which the disclosed subject matter may be utilized, in accordance with some exemplary embodiments of the disclosed subject matter; and

FIG. 6B shows a schematic illustration of an exemplary environment in which the disclosed subject matter may be utilized, in accordance with some exemplary embodiments of the disclosed subject matter.

### DETAILED DESCRIPTION

One technical problem dealt with by the disclosed subject matter is enhancing the intelligibility, clarity, audibility, or other attributes, of audio that is provided to a user, while reducing the listening effort of the user. In some exemplary embodiments, conventional hearing aid devices may be designed for improving hearing and communication abilities of individuals. In some exemplary embodiments, conventional hearing aid devices may be configured to amplify sounds in a user's environment and make them more audible to the user. For example, conventional hearing aid devices may capture sounds using a microphone, convert them into electrical signals, amplify the signals, convert the amplified signals back into sound waves, and deliver them into the user's ear.

In some exemplary embodiments, although conventional hearing aid devices may be helpful in some scenarios, they may be incapable of adequately improving perception of individual sounds for a user. For example, conventional hearing aid devices may function in a sub-optimal manner in case the microphones of the conventional hearing aid devices are distant from a source of sound, obstructed from the source of sound, or the like. As another example, conventional hearing aid devices may function in a sub-optimal manner in noisy environments such as restaurants or multi-participant conversations, where the microphones of the conventional hearing aid devices may not necessarily be able to differentiate between desired sounds, such as voices of people with which the user is conversing, and background noise or speech by other people. For example, the voice of an individual with which the user is speaking may be difficult for conventional hearing aid devices to perceive or comprehend in a noisy environment. In some exemplary embodiments, microphones of conventional hearing aid devices may not be mounted in an optimal position for taking full advantage of directional microphones and noise cancellation. In some exemplary embodiments, conventional hearing aid devices may have a small or limited battery, which may require frequent charging. In some exemplary embodiments, the reliance on limited battery power may reduce processing capabilities of the conventional hearing aid devices, e.g., limiting the conventional hearing aid devices to simple low-resource processing to prevent fast drain of the battery. It may be desired to overcome such drawbacks and increase the intelligibility of audio output that is provided to the user.

Another technical problem dealt with by the disclosed subject matter is enhancing the intelligibility, clarity, audibility, or the like, of audio that is provided to a user via one or more hearable devices, also referred to as “hearables”. In some exemplary embodiments, one or more hearable devices may be used for providing audio output to a user. In some exemplary embodiments, hearables may comprise over-the-counter ear-worn devices that can be obtained without a prescription, and may be designed for a broader audience than conventional hearing aid devices, including for individuals without prescribed hearing loss. For example, hearables may not exclusively focus on addressing hearing loss, and may serve as multifunctional devices for various daily activities (e.g., navigation assistance, music playback, or the like). In some exemplary embodiments, hearables may typically comprise microphones for capturing surrounding sounds, a processor to convert sounds into electrical signals, an amplifier to amplify the signals, a speaker to convert the signals back into sound waves, a Bluetooth™ Integrated Circuit (IC) to communicate with other devices, sensors such as biometric sensors, or the like. In some exemplary embodiments, similarly to conventional hearing aid devices, hearables may not function in an optimal manner in many scenarios, e.g., in noisy environments such as restaurants or multi-participant conversations.

Yet another technical problem dealt with by the disclosed subject matter is utilizing hearables to enhance a user experience of individuals that do not have hearing impairments. In some exemplary embodiments, hearables may be designed for individuals that do not necessarily have hearing impairments, such as by enabling them to concentrate with lower effort on their conversation in a noisy environment. A human brain is able to focus auditory attention on a particular stimulus while filtering out a range of other stimuli, such as when focusing on a single audible stimuli in a noisy room (the ‘cocktail party effect’). However, this brain effort can result in cognitive load and fatigue, as the attempt to filter out irrelevant sounds and focus on the desired stimulus can increase cognitive load and fatigue, and may adversely impact the overall well-being of the user. In some cases, some people may have a difficulty in utilizing the Cocktail Party effect (also referred to as Speech-in-Noise (SIN) perception), and may struggle to discern and understand specific conversations in noisy environments, e.g., leading to increased stress and anxiety, sensory overload, reduced well-being, or the like. It may be desired to overcome such drawbacks, e.g., to enable people to filter out background sounds easily.

Yet another technical problem dealt with by the disclosed subject matter is enhancing the audibility of one or more target entities that a user wishes to hear, e.g., while reducing a listening effort of the user. For example, the user may be located in a noisy environment, may be conversing with multiple people, or the like, and may desire to hear target entities clearly.

Yet another technical problem dealt with by the disclosed subject matter is increasing the directionality capability of hearables. In some exemplary embodiments, hearables may have a certain capability to track directionality of sounds, such as using directional microphones, beamformer microphones, or the like. For example, the directionality of a sound may refer to a direction of a source of the sound with respect to a baseline of a microphone, a defined target, a receiver, a docking point, or the like. In some exemplary embodiments, directional microphones, beamformer microphones, or the like, may be designed to focus on specific sound sources and reduce background noise. For example, beamformer microphones may combine signals from multiple microphone elements in a manner that reinforces a desired audio signal and cancels out noise from other directions, e.g., thereby using signal processing technology to achieve directionality. As another example, directional microphones may enable to capture sound primarily from a specific direction while minimizing pickup from other directions, e.g., thereby using physical design and acoustics to achieve directionality. In some exemplary embodiments, the location of microphones on the hearables may not be in an optimal position to take full advantage of directional microphones. It may be desired to overcome such drawbacks.

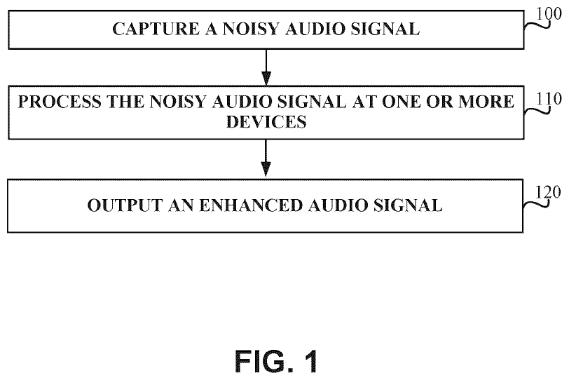

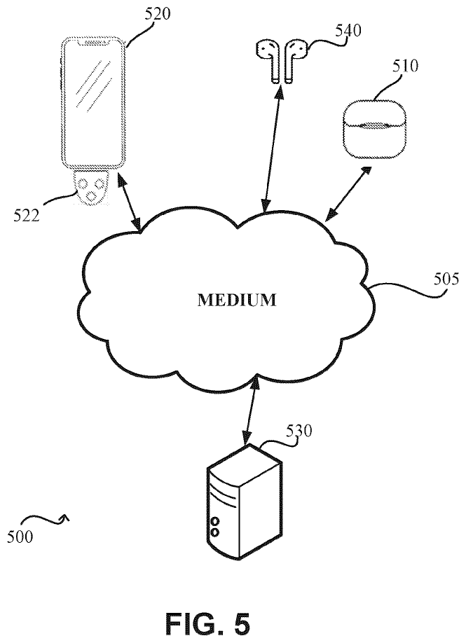

One technical solution provided by the disclosed subject matter, corresponding to the method of FIG. 1, is to position microphones externally to the hearable devices, such as on one or more separate devices. In some exemplary embodiments, instead of relying entirely on microphones that are mounted on the hearable devices, sounds in the user's environment may be captured at one or more additional locations. For example, microphones may be mounted on one or more separate devices, such as a user's mobile device, that are estimated to offer a better signal-to-noise ratio (SNR) for capturing voices of target entities compared to the hearables. For example, devices may be estimated to have a better SNR than the hearables based on the devices' estimated positions, estimated distances from people with which the user is conversing, estimated microphone array sizes and quality, or the like. In some exemplary embodiments, one or more processing operations of a hearable device may be distributed to separate devices, thereby reducing a computational load from the hearable devices and, decreasing a latency inferred by the processing operations, and extending the battery life of the hearable device. For example, the separate devices may correspond to the separate devices depicted in FIG. 5.

In some exemplary embodiments, the user may utilize hearables for obtaining and hearing audio output. In some exemplary embodiments, the hearables may be configured to assist the user by increasing an intelligibility of people in the environment of the user, reducing a background noise, reducing the listening effort of the user, reducing undesired sounds, or the like. In some exemplary embodiments, during a pre-processing stage or phase (also referred to as the ‘capturing stage’), microphones may be configured to capture sound waves in the vicinity of the user. During a processing stage, the sound waves may be converted into digital signals and further processed, e.g., by removing noise, by amplifying voices (also referred to as ‘speech’ or ‘sounds’), by attenuating other voices or sounds, by performing active noise cancelation, or the like. In some exemplary embodiments, during a post-processing stage, processed audio signals may be converted back to sound waves and delivered to the user through the hearables' speakers.

In some exemplary embodiments, the hearables may or may not be adapted to perform passive noise cancellation, e.g., by using silicon tips, by designing the shape of the hearables to partially or fully block users' hearing canals, or the like, thus reducing even further the listening effort and cognitive load of users. In some exemplary embodiments, the hearables may or may not perform active noise cancellation during the processing stage, the post-processing stage, or the like.

In some exemplary embodiments, instead of performing the pre-processing stage exclusively at the hearable devices, the pre-processing stage may be distributed to one or more additional devices. For example, the capturing or recording of noisy audio signals from the environment of the user may be distributed, at least in part, from the hearables to one or more separate devices. In some exemplary embodiments, a separate device may comprise a computing device that is physically separate from the at least one hearable device. For example, a separate device may comprise a mobile device of the user such as a smartphone, a static device of the user such as a computer, a case for storing and/or charging the hearables, a dongle that is connectable and retractable from the mobile device or from the hearables' case, or the like, e.g., as depicted in FIG. 5.

In some exemplary embodiments, one or more separate devices may be placed in the vicinity of the user, enabling one or more microphones mounted thereon to capture audio channels from the user's environment instead of or in addition to audio channels captured by microphones of the hearable devices. In such cases, the one or more separate devices may communicate the captured audio signals, in their raw and/or processed form, to the hearable devices.

In some exemplary embodiments, during the capturing phase, one or more arrays of microphones may capture one or more respective noisy audio signals in the user's environment, e.g., continuously, periodically, or the like. For example, an array may be embedded within a single device, e.g., a single hearable device or a single separate device, may capture a single respective noisy audio signal. As another example, an array may be embedded within two or more devices, e.g., two hearable devices, a hearable device and a separate device, two or more separate devices, or any other combination. According to this example, although the array may be mounted on multiple devices, it may function as a single array in terms of determining the direction of arrival, setting the parameters to a beamformer, audio capturing, or the like. In some exemplary embodiments, the capturing stage may be performed exclusively at the hearable devices, exclusively at the one or more separate devices or a subset thereof, or at a combination that includes at least one hearable device and at least one separate device.

In some exemplary embodiments, after the capturing stage, or at partially overlapping times, the processing stage may be performed. In some exemplary embodiments, during the processing phase, captured audio signals may be processed, such as in order to amplify or enhance speech of entities. In some exemplary embodiments, captured audio signals may be processed by applying thereon one or more audio processing modules, speech separation, filters, compressors, or the like. For example, speech separation may be applied on a noisy audio signal in order to obtain a separate speech stream of a person's voice in the environment of the user. In some cases, captured audio signals may be processed in a manner that is personalized for each user. For example, the user may be provided with a set of predetermined presets of audiogram settings, audio configurations, or the like, and may be enabled to select one of the presets according to their personal situation, segment, preference, or the like. For example, the presets may be separated into categories for different user segments, demographic segments, age ranges, or the like.

In some cases, the speech separation may be configured to extract the speech segment of the person using an acoustic fingerprint (also referred to as “signature”, or “acoustic signature”) of the person, a direction of arrival of the voice of the person, a combination thereof, or the like, e.g., as disclosed in International Patent Application No. PCT/IL2023/050609, entitled “Processing And Utilizing Audio Signals”, filed Jun. 13, 2023, which is hereby incorporated by reference in its entirety without giving rise to disavowment. For example, acoustic fingerprints of target entities (e.g., entities of interest) may be matched to a captured audio signal, and used to generate separate audio signals for each target entity. As another example, an acoustic fingerprint of a person may be used to attenuate the person's voice by reducing a ratio or saliency of their voice from a generated audio output (e.g., using their acoustic fingerprint). For example, a beamforming or learnable model may be used to separate an entity's voice arriving from a specified direction of arrival, and add an attenuated version of the voice to the sound provided to the user, for example in case the user indicates(s) he does not wish to hear a large ratio (e.g., 80%) of the entity's voice. As another example, an acoustic fingerprint of a person may be first applied to identify a voice of the person within the noisy signal, and a direction of arrival of the identified voice may be inferred therefrom and used to enhance the processing of the person's voice over time.

In some exemplary embodiments, instead of performing the processing stage exclusively at the hearable devices, the processing stage may be distributed between two or more devices, e.g., between the hearables, one or more separate devices, or the like. In some exemplary embodiments, during the processing phase, captured audio signals may be processed by one or more devices. In some exemplary embodiments, the processing stage may be performed exclusively at the hearable devices, exclusively at the one or more separate devices or a subset thereof, or at a combination that includes at least one hearable device and at least one separate device.

In some exemplary embodiments, the processing stage may be distributed to one or more separate devices according to a desired speed of computations of each processing operation. For example, processing operations that are required to be performed swiftly, at a delay that is lesser than a threshold, or the like, may be performed at the hearable device, while processing operations that can tolerate a delay (e.g., that do not have a strict latency requirement), may be performed at one or more separate devices and the output may be communicated to the hearable devices. For example, first and second processing operations may be performed independently on different devices, according to their acceptable latency. In some exemplary embodiments, each device that is allocated or assigned to a processing operation of the processing stage, may perform the processing operation using locally captured audio, audio captured by another device, audio obtained from two or more sources of audio, or the like. In some exemplary embodiments, processing of an audio signal may be performed at the device that captured the audio signal, at one or more other devices, or both. For example, a first noisy audio signal may be captured by the hearables, and communicated to a separate device such as a mobile device. Simultaneously, a different separate device such as the dongle may capture a second noisy audio signal and provide it to the mobile device. According to this example, the mobile device may process the first and second noisy audio signals together, in order to generate an enhanced audio signal. In some cases, the processing distribution may not be fixed, but may rather be determined dynamically based on the user's changing environment.

In some exemplary embodiments, at least a portion of an audio signal may be processed locally, and/or communicated to one or more separate devices to be processed thereby. For example, the hearable devices may process locally captured audio channels, alone or in combination with audio channels captured by one or more separate devices and communicated to the hearables. As another example, a separate device may process audio channels captured by the hearable devices, e.g., in case that the separate device did not capture audio signals. As another example, a hearable device may process audio channels captured by one or more separate devices, e.g., in case that the hearable device did not capture audio signals. As another example, a separate device may process one or more captured audio channels that are captured locally by microphones of the separate device, alone or in combination with audio channels captured by one or more other separate devices, by the hearables, or the like, which may be communicated to the separate device.

In some exemplary embodiments, the hearable devices and the separate devices may communicate with one another, with different components of a same device, or the like, e.g., via one or more communication mediums. In some exemplary embodiments, the hearable devices and the separate devices may communicate captured audio signals, e.g., electrical signals, digital signals, analog signals, or the like, via one-way or two-way communications. In some exemplary embodiments, the hearable devices and the separate devices may perform distributed processing operations of the processing stage based on locally captured audio signals, audio signals that are captured by a different device and communicated thereto, a combination thereof, or the like. For example, the hearable devices may capture an audio signal and provide it to one or more separate devices, and obtain one or more additional audio signals from the separate devices, e.g., capturing the signal during the same or partially overlapping timeframes. According to this example, the hearable devices may perform its processing operations on the locally captured audio signal, on the additional audio signals or subset thereof, on both, or the like.

In some exemplary embodiments, after the processing stage, or during timeframes partially overlapping with the processing stage, a post-processing stage may be performed. In some exemplary embodiments, during the post-processing stage, processed data may be obtained from various sources, and an enhanced audio signal may be generated based thereon. In some exemplary embodiments, extracted sounds or voices of target entities may be processed, filtered, combined, attenuated, amplified, or the like, in order to obtain the enhanced audio signal, and the enhanced audio signal may be provided to the user via the hearables. For example, an enhanced audio signal may be obtained by applying digital or analog filters or other operations, such as a Short-Time Fourier Transform (STFT) transformation, Auto Gain Control, or the like, to the noisy audio signal. As another example, an enhanced audio signal may be obtained by applying compressions such as multi-band compressions. In some exemplary embodiments, the post-processing stage may be performed at the hearable devices, or at a separate device. In case the post-processing stage is performed at the separate device, the separate device may communicate the enhanced audio signal to the hearable devices, e.g., to be emitted thereby to the user.

In some exemplary embodiments, in order to perform the capturing stage, at least one array comprising at least two microphones may be deployed within the environment of the user. In some exemplary embodiments, the array of at least two microphones may be embedded within each separate device or within a subset of the separate devices. For example, one or more of the separate devices, e.g., the hearables' case, the mobile device, the dongle, or the like, may each comprise an array of two or more microphones mounted thereon, embedded therein, or the like. In some exemplary embodiments, the array of at least two microphones may be mounted on more than one device. For example, a first separate device may comprise a first single microphone, and a second separate device may comprise a second single microphone. According to this example, the first and second microphones may constitute, together, a microphone array that may be controlled together and communicate with each other via a communication medium. In some exemplary embodiments, an array of at least two microphones may be embedded within the hearable devices. For example, two or more microphones may be mounted on the hearables, such as by positioning at least one microphone at each hearable device. In some cases, two or more arrays of two or more microphones each may be mounted on or embedded within at least one hearable device, a separate device, or the like.

In some exemplary embodiments, an array of at least two microphones may be arranged in one or more defined patterns, e.g., patterns that enable Direction of Arrival (DoA) tracking. For example, the array of at least two microphones may be arranged as a linear array, circular array, triangular array, any other geometric shape, non-geometric shape, or the like. In some exemplary embodiments, the array may identify a spatial separation between arrival times of a signal at each microphone of the array, and may infer the direction from which the sound is coming based on the difference between the arrival times. In some exemplary embodiments, the DoA of a sound may be estimated using a triangulation calculation, beamforming algorithms, or any other signal processing algorithms.

In some exemplary embodiments, a microphone array may comprise at least three noncollinear microphones. In some exemplary embodiments, the microphone array may be arranged as a triangular pattern, e.g., an isosceles triangle, an equilateral triangle, or the like. In some cases, the triangular pattern may be advantageous, at least since a triangular configuration establishes a plane, allowing for the localization of sound sources within the plane. In some cases, an array of microphones may be positioned as an isosceles triangle. In some cases, an array of microphones may be positioned as an equilateral triangle, as this configuration may increase the efficiency of calculations due to symmetry considerations. For example, an equilateral triangular configuration of microphones may enable users to change the direction of the array (e.g., by moving the respective device over which the array is mounted) without adversely affecting the DoA calculation.

In some exemplary embodiments, a microphone array that comprises three or more microphones may be mounted on a single plane having an uninterrupted line of sight to each other. In some exemplary embodiments, the three-microphone array may be embedded within and distributed among one or more separate devices, one or more hearable devices, or the like, e.g., potentially forming a single array over a plurality of devices, forming a single array within a respective device, or the like. For example, three-microphone arrays may be embedded within the hearable devices, the case, and the dongle, respectively. As another example, a three-microphone array may be formed over a plurality of devices, e.g., over first and second hearable devices, each of which having less than three microphones. As another example, a three-microphone array may be formed over a plurality of devices, e.g., over the mobile device and dongle, while functioning as a single array. In some cases, the array may potentially take advantage of existing microphones in the mobile device.

In some exemplary embodiments, a four-microphone array may be mounted on two or more planes, e.g., such that each microphone has a direct, or uninterrupted, line of sight with other microphones of the array. For example, the four-microphone array may be mounted on one or more separate devices, one or more hearable devices, a combination thereof, or the like, e.g., potentially forming a single four-microphone array over a plurality of devices, forming a single four-microphone array within a single device, or the like.

In some exemplary embodiments, an array of at least two microphones of one or more separate devices may be utilized for creating directionality using a beamforming technique, configurations of directional microphones, or the like. It is appreciated that two microphones may be sufficient for localizing sounds coming from a source, in case an angle of the source is located on an axis connecting the microphones. Otherwise, three or more microphones which are not all positioned on one the axis may be required. For example, the beamforming technique may enable to create directionality from an array of microphones mounted on a single device, or from an array of microphones mounted on two or more devices (e.g., a mobile device and an associated dongle). In some cases, the beamforming technique may be used to increase a Signal-to-Noise Ratio (SNR) of audio channels from specified directions.

In some exemplary embodiments, directionality may be created based on beamforming microphones, and may be combined with one or more other processing techniques, such as using acoustic fingerprints of people. For example, an SNR of a person speaking with the user from a direction or angle θ may be enhanced, e.g., compared to using the beamforming technique alone. This enhancement may be achieved by first identifying the person's voice using their acoustic fingerprint, and then determining the Direction of Arrival (DoA) of the person's voice as angle 0 through the beamforming technique. For example, acoustic fingerprints may be applied on audio channels according to the disclosure of International Patent Application No. PCT/IL2023/050609, entitled “Processing and Utilizing Audio Signals”, filed Jun. 13, 2023. According to this example, after identifying a voice of an entity using their acoustic fingerprint, the beamforming technique may be applied to enhance the voice's DoA for the remainder of the conversation between the user and the person using the determined angle.

In some exemplary embodiments, beamforming microphones may be configured to adapt their focus based on the location of the sound source, thereby handling dynamic or changing sound source locations. For example, in case acoustic fingerprints are used to extract one or more voices of interest, a first location of an entity may be identified and enhanced according to extracted sound of the entity, in accordance with their acoustic fingerprint. In case the entity changes its location to a second location, the second location may be tracked using the entity's extracted sound. For example, the entity's acoustic fingerprints may be applied periodically, upon determined events, or the like, such as in order to reduce computational resources. In some exemplary embodiments, the configuration of beamforming microphones may be adjustable manually, automatically, or the like. For example, the user may manually adjust the configuration of beamforming microphones to focus on a selected direction of an entity, on a selected range of angles in a certain direction, or the like.

In one scenario, a user may meet and converse with one or more acquaintances in a noisy environment such as a restaurant, a party, a club, or the like. During the meeting, the user and/or at least some of the acquaintances may change their locations. For example, an acquaintance may move from the right side of the user to their left side. As another example, the entire group may change tables, go dancing, or the like, causing the relative positions of the acquaintances with respect to the user to constantly change. In this scenario, the user may wish to obtain audio input that represents the speech of the acquaintances continuously, from their different relative locations. In some cases, beamforming microphones or directional microphones may be used to automatically identify directions from which voices arrive. In some cases, acoustic signatures may be used to correlate between an angle and a voice of an entity. In some cases, the user may manually indicate angles of interest, e.g., via their mobile device, a dedicated application thereon, or the like. For example, general source separation may be applied on a noisy audio signal, each source being associated with one or more angles, and the user may select angles of entities of interest. In some cases, the user may manually indicate angles that are not of interest, and may not be tracked.

In some exemplary embodiments, an array of beamforming microphones or directional microphones may be mounted on each hearable device, on both, or the like. In some exemplary embodiments, hearables may have a known position relative to the user, the user's head, the user's ears, or the like, which may increase a directionality capability when capturing audio signals from the user. In some exemplary embodiments, the known relative position of the hearables with respect to the user may be utilized for determining a relative position of the user with respect to other entities. For example, in case a voice of an entity is obtained at an angle θ from a line associated with the hearables' microphones, the angle θ may be determined to be the angle between the user and the entity.

In some exemplary embodiments, an array of beamforming microphones or directional microphones may be mounted on a separate device such as the hearables' case, a dongle, or the like. In some exemplary embodiments, since the case and the dongle may have a relatively large surface, for example larger than what is enabled on some hearables, a distance between microphones that are mounted on the case and/or dongle may be increased, e.g., compared to such hearable devices, enabling enhanced audio capturing and processing stages. In some cases, the case and dongle may not have a default position compared to the user, and their relative position may change overtime. The case and dongle may not have a default position compared to other entities of interest, such as a person speaking with the user, making the determination of the relative position of the case and dongle more complex (e.g., compared to the hearables).

In some exemplary embodiments, an array of beamforming microphones or directional microphones may be mounted on a separate device such as the user's mobile device. In some exemplary embodiments, the array of microphones may comprise an existing array of microphones within the mobile device, or a dedicated array of microphones that may be deployed within or over the mobile device. In some exemplary embodiments, since a mobile device may have a relatively large surface, a distance between microphones that are mounted on the case may be increased, e.g., compared to the hearable devices, enabling to enhance the audio capturing and processing of the case.

In some exemplary embodiments, one or more audio signals captured by one or more respective microphone arrays may be processed at a device that is operatively coupled to each microphone array, or may be communicated to a device that is not operatively coupled to the microphone array, to be processed thereby. In some exemplary embodiments, one or more devices may be allocated one or more respective processing operations, and may perform the respective processing operations as part of the processing stage. In some exemplary embodiments, processed data obtained from the processing at each device may be communicated to the at least one hearable device, thereby enabling the at least one hearable device to generate and output an enhanced audio signal to the user.

In some exemplary embodiments, a processing operation may be allocated to more than one device, e.g., causing one or more portions of the computation to be performed at a first device, and one or more portions of the computation to be performed at a second device. In such cases, the first and second devices may be configured to communicate to each other partial computation results, until obtaining a final result that may be provided by at least one of the first and second devices to the hearable device (e.g., unless the providing device is the hearable device).

In some exemplary embodiments, processed data that is generated by a device as a result of performing one or more processing operations, may comprise one or more separate speech segments extracted from a noisy audio signal, one or more filtered sounds, one or more amplified sounds, or the like. It is noted that separate speech segments may refer to speech segments of one or more separate entities, and not to a separation over time. In some exemplary embodiments, separating voices of speakers at a separate device may be more efficient than separating voices at the hearable device, such as in case that the separate device is in closer proximity to participants in the user's conversation (e.g., which improves the SNR), in case that the separate device has a greater distance between microphones of an array, in case that the separate device has better quality microphones, or the like.

In some exemplary embodiments, during the post-processing stage, the processed data may be combined, further processed, synchronized according to their respective different latencies, or the like. For example, different latencies of processed data may be caused by different capturing times of noisy audio signals, different processing times, different transmission times, or the like. In some exemplary embodiments, the processed data may be communicated, from each device that participated in the distributed processing stage, to the at least one hearable device, thereby enabling the at least one hearable device to implement the post-processing stage. In some exemplary embodiments, the processed data may be communicated, from each device that participated in the distributed processing stage, to a separate device, thereby enabling the separate device to implement the post-processing stage. In such a case, a resulting enhanced audio signal may be communicated from the separate device to the at least one hearable device, to be outputted to the user thereby.

One technical effect of utilizing the disclosed subject matter is to provide enhanced audio signals via hearable devices. For example, by distributing the capturing and processing phases to one or more separate devices, the hearables may gain sophisticated processing capabilities of audio while retaining low latencies, e.g., due to the simultaneous processing at devices with larger computational resources, battery life, or the like. For example, the computational capabilities of the disclosed subject matter may be provided by hardware that is embedded within one or more separate devices such as a dongle, a case, a smartphone, or the like. In some cases, speech separation may be more efficient on separate devices such as the user's mobile device, case, dongle, or the like, since these devices may be in closer proximity to participants in the user's conversation compared to the user's hearables, thus improving the SNR.

It is noted that although the disclosed subject matter is exemplified with respect to hearable devices, the disclosed subject matter is not limited to this embodiment. For example, the disclosed subject matter may be implemented by a dedicated non-conventional hearing aid device, which may be designed and configured according to the disclosed subject matter. According to this example, any enhanced audio signal may be converted to acoustic energy by the dedicated hearing aids, instead of by the hearable devices.

Another technical effect of utilizing the disclosed subject matter is enabling the hearables to process each sound independently, together, or the like, providing a full range of functionalities that can be performed on the isolated sounds. For example, increasing a sound of one entity and decreasing a sound of another entity cannot be performed without having independent isolated sounds of both entities. In some exemplary embodiments, due to the distribution of capturing and processing phases, the available computational power for the processing phase may increase, thus allowing to separate speech using sophisticated speech separation techniques such as using acoustic fingerprints of target entities.

Yet another technical effect of utilizing the disclosed subject matter is enhancing a capturing phase (e.g., pre-processing stage) by capturing noisy audio signals using microphone arrays that are positioned in more advantageous positions compared to the hearables. For example, by distributing the capturing stage to a separate device such as the user's mobile device, which may be positioned near individuals with which the user is conversing, the quality of voices of the individuals (e.g., their SNR) may be greater than the quality of their voices as captured by the hearables.

Yet another technical effect of utilizing the disclosed subject matter is enhancing a capturing phase (e.g., the pre-processing stage) by capturing noisy audio signals using microphone arrays that have greater distances between the microphones, compared with the distances of microphones within the hearable devices. For example, since separate devices such as the dongle may have a greater surface area than the hearables, this enables to increase the distance between array microphones, increase the number of microphones within the array, or the like. This may result with enhanced quality of captured audio channels and an improved spatial resolution of the beamforming microphones. The disclosed subject matter may provide for one or more technical improvements over any pre-existing technique and any technique that has previously become routine or conventional in the art. Additional technical problems, solutions and effects may be apparent to a person of ordinary skill in the art in view of the present disclosure.

One technical problem dealt with by the disclosed subject matter is enhancing an audio quality provided by hearables, e.g., to mitigate the occurrence of undesirable delays in the playback of the user's own voice. In some exemplary embodiments, in many cases hearables provide an audio that encompasses voices from the user's environment, including the user's own voice. In some exemplary embodiments, when hearables introduce a delay beyond a defined threshold of the user's own voice (e.g., the threshold depending on the user or an average user), it may lead the user to stutter, speak slowly and even stop speaking due to user frustration and a diminished overall experience (referred to as “the self-hearing effect”). In some cases, users that hear their own voice with a latency may, subconsciously, reduce their speech-rate, which may adversely affect their ability to participate in conversations with other people. It may be desired that playbacks of the user's own voice will not occur in a delay, in a delay that is greater than a threshold, or the like, e.g., in order to enhance the overall usability and satisfaction of hearable devices.

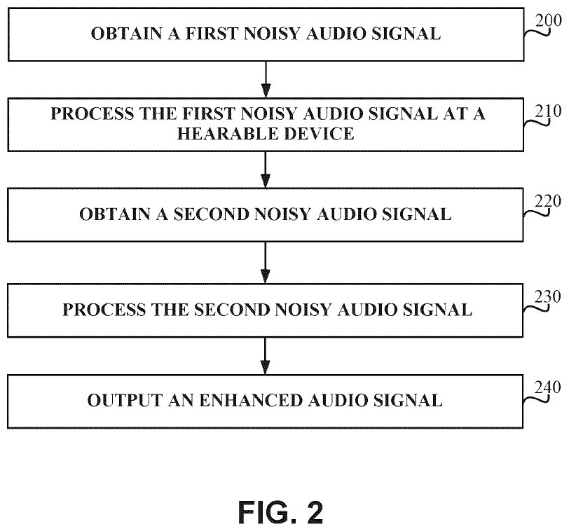

One technical solution provided by the disclosed subject matter, corresponding to the method of FIG. 2, is to separate the user's voice from other voices during a processing stage, and to apply separate processing operations on the user's voice and on other voices of other entities. For example, the processing stage may correspond to the processing stage described above. In some exemplary embodiments, the processing operations applied on the user's voice may result with a reduced latency of the user's own voice, thereby reducing the self-hearing effect.

In some exemplary embodiments, at least one hearable device may be used by a user for providing audio output to the user, e.g., corresponding to the hearable device described above. In some exemplary embodiments, the hearable device may be configured to obtain a noisy audio signal from the environment of the user, such as via one or more microphones, and emit to the user via one or more speakers an enhanced audio signal. For example, the enhanced audio signal may comprise an amplified version of the noisy audio signal, a processed version of the noisy audio signal that removes background noise from the noisy audio signal, a combination thereof, or the like, e.g., as generated on Step 110 of FIG. 1.

In some exemplary embodiments, the noisy audio signal may or may not comprise speech by the user. For example, in case the user speaks, their voice may be captured by microphones of the hearable device, microphones of one or more separate devices, or the like, and may be included in the noisy audio signal.

In some exemplary embodiments, the user's voice may be extracted from the noisy audio signal and may be processed separately from other voices or sounds. In some exemplary embodiments, a separate audio processing may be applied for the user's speech and for other sounds or voices of other people. In some exemplary embodiments, the user's voice may be extracted from the noisy audio signal based on an acoustic fingerprint of the user, a DoA of the user's voice (e.g., with respect to microphones of the hearable devices), the energy or Root-Mean-Square (RMS) of the user's voice, or the like. In some exemplary embodiments, the user's voice may be identified by the hearable device and extracted based on an energy measure such as a RMS of a noisy signal captured by its microphones, an SNR thereof, or the like. In some cases, since the microphones of the hearable device are positioned in close proximity to the user's mouth, the energy level of their voice may be very high, e.g., above a threshold, thus constituting an indicator that can be used to identify the user's voice (e.g., enabling to generate an acoustic fingerprint of the user's voice, to identify a direction of the user's voice, or the like). In some exemplary embodiments, the user's voice may be identified by the hearable device and extracted from the noisy audio signal based on a direction of arrival of the user's voice. For example, since the microphones of the hearable device are positioned in a relatively fixed position compared to the user's mouth, the user's voice may arrive at the microphones at a predetermined angle. In some cases, beamforming techniques may be used to identify the direction of arrival of different sounds, and identify the user's voice according to its direction of arrival.

In some exemplary embodiments, one or more processing operations, such as the processing operations of the processing stage of Step 110 of FIG. 1 that is described below, may be selected to be applied on the user's extracted speech, and one or more different processing operations may be selected for processing speech from other entities. In some exemplary embodiments, the audio processing may comprise one or more processing modules such as speech separation, noise reduction modules, sound extraction modules, filters such as echo cancellers, dereverberation algorithms, or the like. In some exemplary embodiments, processing operations may be selected for the user's voice in case that the processing operations comply with a strict latency constraint (e.g., stricter than the latency constraint of other entities), comply with a strict resource constraint (e.g., stricter than the resource constraint of other entities), a power constraint, or the like.

In some exemplary embodiments, since the user knows what the user said and there is no clarity problem as may occur with the speech of other speakers, the audio processing that is utilized for processing the user's speech may be selected to be simpler, utilize less resources, less complex, or the like, compared to the audio processing that is selected to be utilized for processing other sounds. For example, complex processing that requires a large number of computational resources, may not be selected for the user's own voice, but rather for other entities. For example, voice separation processing that is based on acoustic signatures may be considered complex, while voice separation processing that is based on a direction of arrival, an energy level, or a Signal-to-Noise Ratio (SNR), may be considered simpler. In other cases, voice separation techniques may be classified in any other way. In some exemplary embodiments, by utilizing a simpler audio processing module for the user's voice, a delay incurred by the processing of the user's voice may be reduced, e.g., compared to a delay incurred by a more complex processing. In some cases, the delay incurred by the processing of the user's voice may be reduced to be between two and twelve times shorter than the delay incurred by processing other voices, e.g., in milliseconds time units.

In some exemplary embodiments, one or more distributions of processing operations may be selected for processing the user's extracted speech and other captured speech. In some exemplary embodiments, in order to reduce the delay incurred by the processing of the user's voice, the user's speech may be processed locally at the hearable devices. For example, the noisy audio signal may be processed at the hearable devices by applying a speech separation that is configured to extract from the noisy audio signal the speech segment of the user.

In some exemplary embodiments, the processing of speech emitted by other entities, such as from people in the vicinity or environment of the user, may be distributed to one or more separate devices, may be performed at the hearable devices, a combination thereof, or the like. For example, voices of other entities may be processed at one or more separate devices such as a mobile device of the user, a dongle of the mobile device, a case for storing the hearable device, or the like.

In some exemplary embodiments, in order to distribute the processing stage, a noisy audio signal may be captured by one or more microphones of the hearable devices, and communicated to one or more separate devices to be processed thereby. In some cases, one or more noisy audio signals may be captured locally at one or more separate devices, e.g., similar to Step 100 of FIG. 1. In some exemplary embodiments, in order to reduce an overall latency, processing operations of the processing stage may be implemented simultaneously, in parallel, independently, or the like, at the hearable device and at the one or more separated devices.

In some exemplary embodiments, the distribution of processing operations may be performed according to whether or not the processing operation relates to the user's voice. In some cases, all processing of the user's voice may be performed at the hearable device, while all processing of other sounds may be performed at one or more separate devices that exclude the hearable device and are separate therefrom. In some cases, the processing of the user's voice may be performed at the hearable device, and processing of other sounds may be performed at one or more devices such as the hearable device, one or more separate devices, or the like. For example, the user's voice may be processed by the hearable device, while other voices of other entities may be processed by a mobile device of the user. As another example, the user's voice may be processed separately on the hearable device, while the processing of the other sounds may be distributed at least in part to other separate devices. According to this example, the processing of the other sounds may be performed partially at the hearable device, partially at one or more separate devices such as the mobile device of the user, or the like.

In some exemplary embodiments, the distribution of processing operations may be performed according to whether or not the processing operation is simple, e.g., whether it requires less resources than a threshold. In some cases, all processing operations that are simple may be performed at the hearable device, while all processing operations that are complex, e.g., requiring more resources than a threshold (for example on average per time unit), may be performed at one or more separate devices, regardless of whether or not they relate to the user's voice. For example, the user's voice may be processed by the hearable device, and simple processing operations for other sounds may be performed at the hearable device as well, while more complex processing operations may be performed at one or more separate devices.

In other cases, processing operations may not be distributed to separate devices, e.g., as part of a standalone mode of the hearable devices. For example, the entire processing stage may be implemented at the hearable device, using different voice separation techniques for the user and for other entities. For example, the user's voice may be processed separately on the hearable device using a first voice separation technique, while the other sounds may be processed separately on the hearable device using a second different voice separation technique. According to this example, the first voice separation technique may be simpler than the second voice separation technique, e.g., utilizing less resources than the second voice separation technique, having a smaller delay than the second voice separation technique, or the like.

In some exemplary embodiments, after processing one or more noisy audio signals at one or more separated devices, the one or more separated devices may communicate processed audio signals to a single device (a hearable device or separate device) for a post-processing stage. In some exemplary embodiments, the communication to and from the single device may incur a communication delay.

In some exemplary embodiments, by ensuring that the user's voice is processed locally at the hearable device, and that the user's voice is processed using low-latency audio processing techniques, the latency of the user's voice may be reduced. For example, an enhanced audio signal that is generated based on the noisy audio signal may comprise the user's voice with a first latency, and at least a portion of the remaining voices with a second latency, where the first latency is lesser than the second latency. In some cases, the first latency of the user's voice may be devoid of a communication latency between the hearable devices and a separate device, at least since the user's voice may be processed locally.

In some cases, in order to reduce a communication latency, instead of capturing a noisy audio signal at the hearable devices and communicating it to one or more separate devices for processing thereof, a first noisy audio signal may be captured at the hearable device, and one or more second noisy audio signals may be captured at one or more separate devices, e.g., during timeframes that overlap at least in part. In some exemplary embodiments, the separate devices may capture the noisy audio signals locally, and apply thereon one or more voice separation processes, background removal processes, or the like, thereby eliminating a latency incurred by obtaining the noisy audio signal from the hearable devices. In some exemplary embodiments, after processing the locally captured noisy audio signals, the one or more separate devices may communicate the processed signal to a single device for the post-processing stage.

For example, in one scenario the hearable device may capture a first noisy audio signal, and process the signal to extract therefrom the user's voice using a first speech separation. Simultaneously, a separate device such as the user's mobile device may capture a second noisy audio signal in the same environment, and process the signal to extract therefrom speech emitted by a second person in the environment using a second speech separation. According to this example, the processed second noisy audio signal may be communicated from the separate devices to the hearable device, and used to generate and output an enhanced audio signal to the user. According to this example, the extraction and processing of the second person's voice may utilize more resources and introduce higher latency than the extraction and processing of the user's voice.

In some exemplary embodiments, processing operations that are distributed between one or more separate devices, may not involve the user's voice, speech, or the like. For example, in case the processing operations comprise applying one or more acoustic fingerprints on the noisy signal in order to identify one or more entities of interest that exclude the user, the user's voice may not be extracted by the processing operations, and may not be communicated to the device performing the post-processing stage. According to this example, voices of entities of interest may be identified, extracted, and processed by the separate devices, such as in order to increase its clarity or volume, to reduce noise, remove reverberation, to increase an intelligibility of the entities, or the like, while the user's voice may not be processed or extracted by the separate devices.

In some cases, processing operations that are distributed between one or more separate devices, may involve the user's voice, speech, or the like. For example, in case that the processing operations comprise applying a general speech separation such as source separation to identify and separate all speech segments in the noisy signal, the user's voice may be extracted along with any other voice that is present in the captured audio. In such cases, the user's voice may be removed, not processed, not communicated to other devices, or the like, such as in order to prevent duplication. For example, since the hearable devices are tasked with processing the user's voice, the separate devices may advantageously not process the same voice of the user a second time with an increased latency, e.g., as this will waste resources, increase an overall latency, and may result with an undesired duplicated sound of the user in an output audio.

In some exemplary embodiments, the user's voice may be removed at the separate device, at the single device that performs the post-processing, or at the hearable devices. For example, a separate device may obtain an acoustic fingerprint of the user's voice, and utilize the acoustic fingerprint in order to remove the user's voice from a processed audio generated by the separate device. For example, the separate device may utilize the acoustic fingerprint in order to ensure that a resulting processed signal is devoid of the user's voice. In some cases, the separate device may obtain a direction of arrival of the user's voice, and utilize the direction of arrival in order to ensure that a resulting processed signal is devoid of the user's voice. In other cases, the separate device may include the user's voice in a generated processed audio signal, and provide the processed audio signal to a single device, e.g., the hearable devices, or any other device that is configured to perform the post-processing stage. In such cases, the user's voice may be removed by the single device, e.g., based on an acoustic signature of the user, a DoA of the user's voice, the energy level or RMS of the user (by determining that the user's voice will have a highest energy level in an audio signal captured by the hearable device). In some cases, the hearable device may be configured to remove the user's voice from an obtained processed signal based on an SNR of the user's voice in a noisy signal that is captured locally at the hearable device.

Although the description above relates to removing a voice when using a general speech separation, it is appreciated that in some embodiments other speech separation modules may be used, in which the audio to be output is generated by accumulating segments of audio from one or more sources, without separating the user's voice from noisy audio signals, channels, or the like.

In some exemplary embodiments, a post-processing stage may be implemented by a single device, e.g., the hearable devices. In some exemplary embodiments, during the post-processing stage, processed audio channels from all sources may be combined, synchronized, filtered, or the like, into an enhanced audio signal, e.g., similar to Step 120 of FIG. 1. In some exemplary embodiments, the enhanced audio signal may be generated to include the user's voice with a small latency (e.g., less than a threshold) or no latency, and to include other voices of other entities of interest with a larger latency (e.g., greater than the threshold). In some exemplary embodiments, the enhanced audio signal may be emitted by the hearable devices to the user, e.g., via speakers.

One technical effect of utilizing the disclosed subject matter is to enhance an audio output of a hearable device such that the user will not hear their own voice with a latency that is greater than a threshold. The disclosed subject matter mitigates the occurrence of undesirable delays in the playback of the user's own voice, by separating the processing of the user's voice from processing of voices belonging to other entities.

Another technical effect of utilizing the disclosed subject matter is to increase an ability of a user to take part in conversations, without reducing their speech pace due to the latency of their own voice as emitted by their hearable devices. By reducing the latency of the user's voice to a low threshold, the overall usability and satisfaction of hearable devices may increase. The disclosed subject matter may provide for one or more technical improvements over any pre-existing technique and any technique that has previously become routine or conventional in the art. Additional technical problems, solutions and effects may be apparent to a person of ordinary skill in the art in view of the present disclosure.

One technical problem dealt with by the disclosed subject matter is enhancing the performance of operations of the disclosed subject matter for different contexts, situations, scenarios, or the like. In some cases, a tradeoff may exist between a quality of audio that is produced by the disclosed subject matter, (e.g., the method of FIG. 1 and the separation of the user's voice method of FIG. 2, as described below), and between a latency thereof. For example, using complex speech separation modules may increase a quality of a produced audio signal, while concurrently increasing a latency that is incurred by the processing stage, and vice versa. It may be desired to overcome these drawbacks.

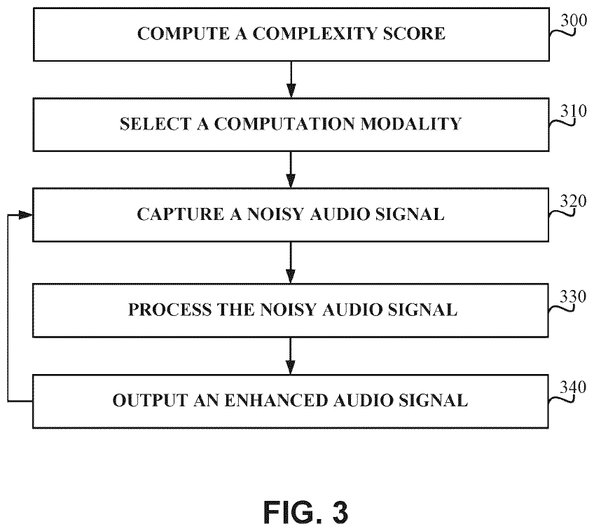

One technical solution provided by the disclosed subject matter, corresponding to the method of FIG. 3, is to match a computation modality of the disclosed subject matter to different dynamic situations in the user's environment. In some exemplary embodiments, complex situations, such as multi-participant conversations, may be processed utilizing more complex and sophisticated processing methods (e.g., using acoustic fingerprints), which may result with a relatively high latency but better quality and accuracy. In some exemplary embodiments, in simpler situations, the audio may be processed utilizing simpler and less sophisticated processing methods, which may result with a lower latency.

In some exemplary embodiments, a computation modality may refer to a complexity class that is determined for processing operations (e.g., ‘simple’, ‘intermediate’, and ‘complex’), to a level of resources determined for processing operations, to a tolerable level of latency, to a location of processing each processing operation (e.g., at which device), or the like. In some cases, each class of processing operations, or level of resources, may correspond to different speech separation modules. For example, a first computation modality may indicate a ‘simple’ complexity class, a low level of resources, a low tolerance to latency, and a processing location at the hearable devices, while a second computation modality may indicate a ‘complex’ complexity class, a high level of resources, a high tolerance to latency, and a processing location at one or more separate devices.

In some exemplary embodiments, the conversation scenario or context of the user may be detected, determined, or the like, and a decision regarding the computation modality (also referred to as ‘processing mode’) may be dynamically made based on the conversation scenario. In some exemplary embodiments, the conversation scenario or context may be utilized for determining a complexity score of a conversation in which a user participates, and the complexity score may be utilized for determining a matching computation modality.

In some exemplary embodiments, a complexity score of the user's conversation may be dynamically determined, calculated, adjusted, or the like, such as according to a dynamically changing environment of the user. In some exemplary embodiments, the complexity score may be determined based on a context of the conversation, such as a background noise level of the conversation, a volume of the conversation, an SNR of the conversation, whether the background noise is stationary or not (e.g., having a consistent frequency, amplitude, or other characteristics), or the like.

For example, the complexity score may increase on a monotonic scale with the background noise level of the conversation. As another example, as the volume of the conversation increases, the complexity score may decrease monotonically, e.g., since the conversation may be easier to follow by the user and to process by the disclosed subject matter. As another example, as the SNR of the conversation increases, the complexity score may decrease monotonically, e.g., since the conversation may be easier to follow by the user and to process by the disclosed subject matter in case of a high SNR. As another example, as the background noise is more stationary, the complexity score may decrease monotonically, and vice versa.

In some exemplary embodiments, it is noted that the complexity score may be expressed as a simplicity score. For example, the complexity score may be denoted by Com(Conv), and a respective simplicity score may correspond to another monotonic function, such as 1/Com(Conv).

In some exemplary embodiments, the complexity score may be determined based on whether the frequencies of the conversation overlap with the frequencies of the background noise. For example, in case the frequencies of the background noise overlap with the frequencies of the conversation (e.g., also referred to as ‘informatic masking’), the processing of the audio signals may be more challenging, and the complexity score may increase respectively. In such cases, the complexity of the processing of the audio signals may depend on the SNR level of the conversation, and the complexity score may be adjusted accordingly. In other cases such as non-speech audio, cases where the frequencies of the conversation do not overlap with the frequencies of the background noise (e.g., also referred to as ‘energetic masking’), other situations in which the burden on the listener is low, or the like, the processing of the audio signals may be simple, e.g., even with a low SNR of the conversation. In some exemplary embodiments, the complexity score may be affected by the narrow or wide band frequencies in the captured audio. For example, the complexity score may be determined to be lower for wide band frequencies, and higher for low band frequencies for a given SNR, and optionally depending on the context of the captured audio (e.g., whether it includes speech, transportation noise, or the like).

In some exemplary embodiments, the complexity score may be determined based on the voices in the conversation being similar (e.g., having overlapping frequencies, having acoustic signatures that are highly similar, or the like). For example, the complexity score may be lower for non-similar voices, and higher for each pair of similar voices. In some cases, the complexity score may be higher for same-gender conversation, due to similar sound frequencies.

In some exemplary embodiments, the complexity score may be determined based on the number of participants in the conversation, their speaking volume, their distance to the microphone array, or the like. For example, in case the number of participants in the conversation is determined to be high (e.g., above a threshold), the complexity score may be higher, and vice versa. In some cases, the number of participants may be inferred from other parameters (e.g., the SNR of the conversation), indicated by the user, determined based on a general speech separation (e.g., without acoustic signatures), or the like.

In some exemplary embodiments, the complexity score may be determined based on a level of concurrent speech in the conversation. For example, in case two or more voices speak concurrently, the complexity score may be higher, and vice versa.

In some exemplary embodiments, the complexity score may be determined by accumulating values of different parameters associated with the complexity of the conversation, e.g., parameters relating to the estimated number of participants in the conversation, SNR level, background noise level, or the like. In some exemplary embodiments, the complexity score may be determined based on such parameters, a subset thereof, or the like. In some cases, the parameters may or may not be weighted. In some exemplary embodiments, the complexity score may be determined by accumulating a number of parameters that are activated. For example, parameters may be defined as binary parameters that can either be activated or deactivated. According to this example, each parameter that exceeds a defined threshold may be activated, and the complexity score may be determined based on a number of activated parameters.

In some exemplary embodiments, an overall weighted value, or a number of activated parameters, may be compared to one or more thresholds, to determine a level of complexity of the conversation. For example, in case the number of activated parameters exceeds a threshold, the scenario may be determined to be complex, and vice versa. As another example, in case an accumulated value of different parameters is between a first threshold and a second threshold, a first level of complexity may be determined, and in case the value is between the second threshold and a third threshold, a higher level of complexity may be determined, and so on. For example, in case more than two classes of complexity are defined, the processing stage may be separated to more than two respective classes of processing operations, consuming increasing resources. For example, speech separation types may be classified into classes according to complexity, resource utilization, or the like. According to this example, a most complex class may involve using acoustic signatures, a second, lower, complexity class may involve using DoAs for speech separation, and a next complexity class may involve general source separation techniques.

In some exemplary embodiments, a computation modality for the conversation may be selected based on the complexity score, thereby obtaining a selected computation modality. For example, a computation modality may be selected to comprise the respective class of processing operations (e.g., ‘simple’, ‘intermediate’, and ‘complex’). In some exemplary embodiments, the computation modality may define how many resources should be allocated for each processing operation, which speech separation modules should be applied, a location where each processing operation is scheduled to be performed, or the like. For example, each class of processing operations may be associated with a set of one or more processing operations, with one or more resource constraints, with one or more latency constraints, or the like.

In some exemplary embodiments, the computation modality may comprise a type of speech separation. For example, in case the complexity score of a conversation is less than a threshold, a simple speech separation may be used that utilizes a small number of resources, that does not use acoustic fingerprints, or the like. As another example, in case the complexity score of a conversation is greater than a threshold, a complex speech separation may be used that utilizes a large number of resources, that uses acoustic fingerprints, or the like. In some exemplary embodiments, the selected computation modality may indicate which type or class of speech separation should be applied.

In some exemplary embodiments, the selected computation modality may indicate other processing operations that should be performed (e.g., filtration), types thereof, or the like, e.g., according to the complexity score. In some cases, some computations may be mandatory for the processing stage, and may be required to be performed regardless of the computation modality. In such cases, the computation modality may not necessarily indicate such computations, and they may be performed at a default location, e.g., at the hearables.

In some exemplary embodiments, the computation modality may comprise a distribution of the processing stage. In some exemplary embodiments, the computation modality may define at which device each processing operation of the processing stage should be performed. In some exemplary embodiments, the computation modality may indicate one or more designated devices that are selected for processing, e.g., the hearable device, one or more separate devices, or the like. For example, in case the complexity score of a conversation is less than a threshold, the processing stage may be performed locally on the hearable device. As another example, in case the complexity score of a conversation is greater than a threshold, the processing stage may be distributed, at least in part, to one or more separate devices for performing the computations, e.g., according to an availability of separate devices in the environment, a cost function, an objective function, or the like. In such cases, the processing stage may comprise one or more processing operations configured to manage different latencies of audio signals that may be captured and/or processed at different devices, e.g., as may be indicated by the selection of the computation modality.

In some exemplary embodiments, one or more noisy audio signals may be captured and processed according to the selected computation modality, thereby generating respective enhanced audio signals. In some exemplary embodiments, noisy audio signals may be captured from the environment, e.g., similar to Step 100 of FIG. 1. In some exemplary embodiments, enhanced audio signals may be converted from digital to acoustic energy, and outputted to the user via the at least one hearable device, e.g., similar to Step 120 of FIG. 1.

In some exemplary embodiments, the computation modality may be determined periodically, upon an identified event, in response to a user command, available resources such as remaining battery power, or the like. For example, processing modes may be switched to be performed at different devices, or may be switched within a single device according to a user's command, according to determined events, or the like. For example, in case a complex speech separation is scheduled by the computation modality to be performed at a mobile device of the user, and an event of low connectivity between the mobile device and the hearables is detected, the selection of the computation modality may be adjusted to remove the mobile device from a list of available separate devices. According to this example, a subsequent computation modality may be selected, indicating that the complex speech separation should be performed at a different separate device, that a simple speech separation should be performed instead of the complex speech separation at the hearables, or the like.

One technical effect of utilizing the disclosed subject matter is the ability to match requirements and capabilities of different processing operations according to a dynamically changing environment, context, available resources, or the like. For example, the disclosed subject matter enables to provide high quality audio output in complex situations, using sophisticated speech separation, while providing low-latency audio output in simple situations where complex processing is not required. This enhances the user experience and reduces unnecessary usage of computational resources.

The disclosed subject matter may provide for one or more technical improvements over any pre-existing technique and any technique that has previously become routine or conventional in the art. Additional technical problems, solutions and effects may be apparent to a person of ordinary skill in the art in view of the present disclosure.

One technical problem dealt with by the disclosed subject matter is how to enhance a sound provided by a hearable device, such that a directionality of the sound is retained. For example, a user may be speaking with another person, and may use a hearable device to process and enhance the speech of the other person.

In some cases, the user may desire to obtain the enhanced speech in a manner that sounds as if the speech originates from the person. It may be challenging to cause enhanced speech that technically originates from a processing unit of the hearable device, to sound as if it originates from the person, due to a number of reasons. For example, sound waves generated by the processing unit based on digital audio may reach the user from a different angle than the person, in case that the person and the processing unit are not aligned relative to the user. As another example, it may be challenging to cause speech that is captured from a microphone array to sound as if it originates from the person, at least since the person and the microphone array may not necessarily be aligned relative to the user. For example, the microphone array may not necessarily be mounted on the user's ears, head, or the like. As another example, due to constraints such as computational constraints and latency constraints, the processing unit may output a monophonic (mono) channel, which may not provide directionality.

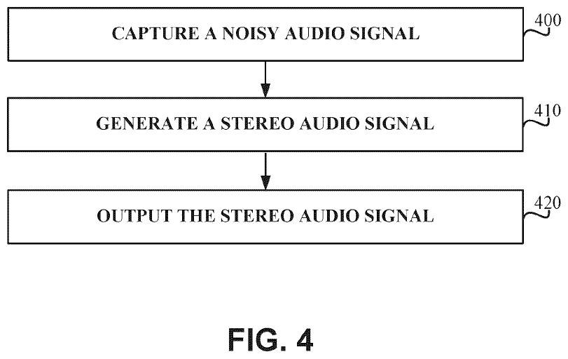

One technical solution provided by the disclosed subject matter, corresponding to the method of FIG. 4, is to generate a stereo audio signal that simulates a directionality of sound, regardless of the actual angle of sound waves produced by the hearable device that reaches the user.

In some exemplary embodiments, a noisy audio signal may be captured by an array of microphones, such as using beamforming techniques, directional arrays, or the like. In some exemplary embodiments, the array of microphones may be mounted on the hearable device of the user, which may comprise a left ear module and a right ear module. For example, a left ear module may be mounted with at least one microphone of the array, and a right ear module may be mounted with at least one microphone of the array. In some exemplary embodiments, the array of microphones may be mounted on a separate device that is physically separate from the hearable device, e.g., a mobile device, a dongle, a case, or the like. For example, the array of microphones may be mounted on a single separate device or on a combination of devices, such that the audio may be captured similar to Step 100 of FIG. 1.

In some exemplary embodiments, the noisy audio signal may be processed in one or more manners, such as by applying one or more speech separations in the signal. In some exemplary embodiments, instead of distributing the processing stage between two or more devices, such as to be performed separately at each earbud of the hearable device, the processing stage may be performed at a single processing unit. For example, the processing unit may be embedded in a hearable device, in a separate device, or the like. In some cases, two or more devices may collectively act as a unified processing unit in case they collaboratively engage in processing tasks via multiple communications.

In some exemplary embodiments, the processing unit may be configured to generate two separate audio signals from the captured audio; one signal for each hearable device. In some exemplary embodiments, the processing stage may generate a first audio signal for a right ear module of the hearable device, and a second audio signal for a left ear module of the hearable device. In some exemplary embodiments, in order to maintain a directionality in the provided audio signals, the processing stage may be adjusted to include an injected delay in one of the generated audio signals (e.g., for the left ear or for the right ear). In some exemplary embodiments, injecting a determined delay into one of the first and second audio signals, may create an effect of directionality, in which the synthesized sound is psycho-acoustically perceived as coming from a direction of the ear that did not obtain the delayed signal.

In some exemplary embodiments, a desired delay may be determined based on a direction of arrival of one or more sounds in the noisy audio signal. In some exemplary embodiments, a desired delay may be determined based on a direction of arrival of a sound of a target entity at a capturing device, e.g., at a separate device such as a mobile device of the user, a dongle, a case, or the like. For example, one or more beamforming receiving arrays or learnable methods (such as neural networks that are trained for DoA estimation) may be utilized by the processing unit to estimate a DoA of s a target entity with which the user is conversing.

In some cases, the DoA of the sound emitted by the target entity may be determined to be a dominant direction of channels of the noisy audio signal, e.g., determined by applying a beamformer on each angle, on each set of angles, or the like, and determining a score for each set of angles. In some exemplary embodiments, the dominant angle may be determined based on the score, e.g., by selecting a highest score, a highest average score for a set of adjacent angles, or the like. In some exemplary embodiments, a score may be assigned to a single angle, denoted by θ, or to a range of angles, and these may be determined to be the DoA of the target person with respect to the array of microphones. In some cases, the dominant angle may be verified to be associated with the target entity, such as by ensuring that the acoustic signature of the entity matches the audio signal arriving from the dominant angle. In case the dominant angle does not match the acoustic signature, the audio signal arriving from the dominant angle may be compared to other acoustic signatures of other entities, to identify a different target entity. In some cases, different angle range bins may be assigned to different entities, indicating the direction of the entities with respect to the array of microphones.

In some exemplary embodiments, in addition to determining the DoA of the target entity with respect to the array of microphones that capture the audio signal, an angle between the user and the microphone array may be determined. For example, θ1 may denote the angle between an axis (or line) connecting the target entity and the array of microphones, and between the baseline or axis within the array of microphones. The angle θ2 may denote the angle between the axis connecting the user and the array of microphones, and between the baseline or axis within the array of microphones.

In some cases, high communication rates may be required to enable feasible usage of the disclosed subject matter, e.g., between the hearable devices and a dongle, case, mobile device, within a same device, or the like.

In some exemplary embodiments, the angle θ2 as defined above may be determined based on an acoustic signature of the user, based on their SNR as captured at the hearable device, triangulations between different microphone arrays on different devices, Fine Time Measurements, Time of arrival (TOA) algorithms (e.g., measuring a difference in time between microphones' signal receptions, all of which can be either traditional or statistical (learnable)), or the like. In some exemplary embodiments, the angle θ1 between the user and the microphone array may be determined for each ear of the user, for the head of the user, or the like. For example, an angle θ1 may be measured between each earbud of the hearable device and the microphone array or its baseline axis. As another example, an average of the angles measured between each earbud of the hearable device and the microphone array may be determined to comprise an angle between the user's head and the microphone array. It is noted that, unless stated otherwise, an angle between a person and an object may be interpreted as an angle between an axis or line connecting the user and the object, and between a baseline of the object (or line of sight if the object is a person). For example, the baseline of the object may comprise a base axis of the object, a core line of the object, or any other longitude or latitude line representing a direction or layout of the object.

In some cases, an angle between the target entity and the microphone array, or any other defined anchor may be determined using a beamforming receiver array, a learnable probabilistic model, a Time Difference of Arrival (TDoA) model, a data-driven model such as a CNN, a RNN, a Residual Neural Network (ResNet), a Transformer, a Conformer, or the like. For example, a scalar, such as a value between the range of [−180, +180) degrees, a normalized range of [−π, π), or the like, may be determined to correspond to the angle between the target entity and the microphone array.

In some exemplary embodiments, based on the determined angles θ1 and θ2, an angle between the user and the target entity, denoted θ3, may be determined. In some exemplary embodiments, a desired delay may be determined based on an angle between the user and the second person, θ3. For example, the delay may be determined to correspond to the speed of sound associated with the distance between the user and the second person, and the delay may be injected in the audio associated with the user's ear that is further away from the target entity.

In some cases, high communication rates may be required to enable feasible usage of the disclosed subject matter, e.g., between the hearable devices and a dongle, case, mobile device, within a same device (between earbuds of the hearable devices), or the like.

One technical effect of utilizing the disclosed subject matter is providing users with a stereo experience that retains a directionality of voices in a conversation. In some exemplary embodiments, by injecting a delay into an audio signal output of one ear, and not the other, and matching the delay to the distance between the user and the target entity, the disclosed subject matter provides the user with a stereo experience that simulates the original directionality of the conversation. In some cases, the presence of microphones in the hearable device may enhance the user's stereo experience.

The disclosed subject matter may provide for one or more technical improvements over any pre-existing technique and any technique that has previously become routine or conventional in the art. Additional technical problems, solutions and effects may be apparent to a person of ordinary skill in the art in view of the present disclosure.

Referring now to FIG. 1 showing an exemplary flowchart diagram, in accordance with some exemplary embodiments of the disclosed subject matter.

On Step 100, a noisy audio signal from an environment of a user may be captured by two or more microphones of at least one separate device, by one or more microphones of the hearable devices, or the like. For example, the noisy audio signal may be captured as part of a pre-processing stage. In some exemplary embodiments, the noisy audio signal may be represented in the time domain, frequency domain, or any other representation.

In some exemplary embodiments, a plurality of people may be located in the user's environment, converse with the user, or the like, and voices of at least a portion of the people may be captured in the noisy audio signal. In some exemplary embodiments, the user's environment may comprise one or more separate devices. In some exemplary embodiments, a separate device may be physically separate from at least one hearable device of the user that is used for providing audio output to the user. In some exemplary embodiments, a separate device may comprise a case of the hearable device, a dongle that is configured to be coupled to a mobile device of the user, a mobile device of the user, a combination thereof, or the like.

In some exemplary embodiments, hearable devices may be used for processing noisy audio signals and providing based thereon audio output to the user. In some exemplary embodiments, a hearable device may comprise wireless or wired earphones, wireless or wired headphones, wireless or wired earplugs, a Bluetooth™ headset, a bone conduction headphone, electronic in-ear devices, in-ear buds, noise-canceling earbuds (e.g., using Active Noise Cancellation (ANC)), or the like. In some exemplary embodiments, at least one speaker may be embedded within a hearable device for emitting output sounds to the user. In some cases, the user's hearables may utilize active or passive noise cancellation, in order to reduce the level of noise that reaches the user from the environment.

In some exemplary embodiments, one or more noisy audio signals from the environment of the user may be captured by one or more microphones. In some exemplary embodiments, a noisy audio signal may comprise a noisy, or mixed, audio sequence, which may comprise one or more background noises, one or more human voices, one or more non-human voices, or the like. In some exemplary embodiments, a noisy audio signal may comprise a first speech segment of the user, a second speech segment of another entity (human or non-human), or the like. In some exemplary embodiments, the noisy audio signal may have a defined length, such as a defined number of milliseconds (ms), a defined number of seconds, or the like, and noisy audio signals may be captured periodically according to the defined length (e.g., chunks of 5 ms, 10 ms, 20 ms, or the like). In some exemplary embodiments, the noisy audio signal may be captured continuously, periodically, or the like. For example, the noisy audio signal may be captured sample by sample, e.g., without gaps.

In some exemplary embodiments, a noisy audio signal may comprise one or more audio channels that are captured by one or more respective microphones. For example, at least one microphone may be embedded within a hearable device and used for capturing audio. As another example, at least one microphone may be embedded within a separate device and used for capturing audio. According to this example, one or more microphones may be embedded in a mobile device of the user such as a smartphone, in a computing device such as a Personal Computer (PC), within hearables, within a wearable device, within a dedicated device, within a dongle connected to a smartphone, within a storing and charging case of a hearable, or the like.

In some exemplary embodiments, microphones may be embedded within a device, mounted on a surface of a device, or the like. It is noted that when relating to microphones that are embedded in a device, the disclosed subject matter is equally applicable to microphones affixed to the device or mounted thereon. In some exemplary embodiments, one or more microphones may be embedded in a separate device such as a case of the hearable device, a dongle that is configured to be coupled to a mobile device of the user, a mobile device of the user, or the like. For example, microphones may be embedded in a case of the hearable device that enables to store and/or charge the hearable device therein. As another example, microphones may be embedded in the dongle, e.g., on a surface thereof, within the dongle, or the like. As another example, microphones may be embedded in the mobile device such as a tablet, a laptop, a user device, an on-board computing system of an automobile, an Internet server, or the like, e.g., taking advantage of existing microphones thereof. In some cases, microphone arrays may be embedded in each separate device that is present in the user's environment, in a subset of separate devices, or the like.

In some cases, one or more microphones that are embedded in a device may comprise an array of three microphones positioned as vertices of a substantially equilateral triangle. In such cases, a distance between any two microphones of the three microphones may be substantially identical, and may comply with a minimal distance threshold. In some cases, one or more microphones that are embedded in a device may comprise an array of three microphones positioned as vertices of a substantial isosceles triangle. In such cases, a distance between a first microphone and each of a second and third microphones may be substantially identical. For example, the array of three microphones may be embedded within a mobile device, one or more hearable devices, a case of the hearable devices, a dongle connectable and retractable from the mobile device, a dongle connectable and retractable from the case, or the like.

In some exemplary embodiments, the term ‘substantially’ concerning two objects, as used herein, may indicate a relationship between the objects that does not exceed a specified degree of variation. For example, in case the degree of variation is 10%, an array of three microphones may be considered to be positioned as a substantially equilateral triangle in case a variation of the array from an equilateral triangle is less than 10%. As another example, in case the degree of variation is 10%, the distance between each microphone pair of the array may be considered to be substantially identical in case a maximal variation between distances of different microphone pairs is less than 10%. In some exemplary embodiments, the degree of variation may comprise a statically determined degree, a dynamically determined degree, or the like, and may or may not be defined separately for different objects. For example, the degree of variation may be set to 2%, 5%, 10%, 15%, or the like.

In some exemplary embodiments, one or more microphones that are embedded in a device may comprise at least three microphones in a single plane, at least four microphones in a single plane, at least four microphones in different planes, or the like. In some cases, a separate device may comprise an array of at least three microphones that are not aligned, and maintain an uninterrupted line of sight with each other. In some cases, a separate device may comprise an array of at least three microphones (e.g., four microphones) that are positioned in different planes, on a same plane, or the like, and maintain an uninterrupted line of sight with each other. For example, an array of at least four microphones may be mounted over a separate device in two or more planes while maintaining an uninterrupted line of sight with each other, thereby enabling the array to function properly even if the array is displaced in three degrees of freedom.

In some exemplary embodiments, an array of two or more microphones may be associated with a single device or with a plurality of devices. For example, an array may be formed from two or more microphones that are deployed over a single separate device (e.g., a case, a dongle, a hearable device, or the like). As another example, an array may be formed from two or more microphones that are deployed, respectively, over two or more separate devices (e.g., a case and a dongle, a hearable device and a dongle, a case and a mobile device, or the like). The microphones may communicate therebetween, for example, a microphone of the case may communicate with a microphone of the dongle or the mobile device, and may together constitute and function as a single array of two microphones, e.g., in terms of identifying sound directionality, capturing audio channels, or the like.

On Step 110, the noisy audio signal may be processed, e.g., as part of a processing stage. In some exemplary embodiments, the noisy audio signal may be processed at least by applying one or more speech separation models thereon, to isolate one or more sounds or voices of respective entities. In some exemplary embodiments, during a post-processing stage, the isolated speech signals that are extracted by the speech separation models from the noisy audio signal may be further processed, combined, synchronized, or the like, to generate an enhanced audio signal.

In some exemplary embodiments, the processing of the noisy audio signal may be distributed, at least partially, between the hearable devices and the at least one separate device. For example, the processing of the noisy audio signal may be distributed between one or more of the hearable devices, the case, the dongle, the mobile device, a subset thereof, or the like. In some exemplary embodiments, in case the processing of the noisy audio signal is distributed between two or more devices, the processing may comprise communicating captured audio signals between the devices. For example, captured audio signals may be communicated between the case, the dongle, the hearable devices, and the mobile device.

In other cases, the processing stage may not be distributed from the hearable devices to any other device in one or more defined scenarios, e.g., in case that the communication medium is disrupted, in case that separate devices have a low connectivity, in case that the hearable devices cannot reach a separate device, or the like. In some exemplary embodiments, although not optimal, the hearable device may enable a standalone mode for limited scenarios. In some cases, during a standalone mode, one or more microphones of the hearable device may be configured to capture a noisy audio signal from the environment of the user, independently from any noisy audio signals that are captured by separate devices, e.g., during a same timeframe or partially overlapping timeframes. In such cases, the hearable device may operate to process and output a locally captured noisy audio signal irrespective of a connectivity between the hearable device and any separate device, thereby enabling the processing stage to not be entirely dependent on separate devices. For example, a standalone mode of the hearable devices may be activated, causing all processing computations to be performed at the hearable device.

According to this example, the standalone mode may have limited battery and computational resources, as it may rely entirely on the resources of the hearable devices, and thus may perform only simple processing operations such as noise reduction, e.g., without using complex speech separation such as using acoustic fingerprints.

In some exemplary embodiments, a selection regarding how to distribute the processing operations between the different devices (the hearable device and the at least one separate device), may be determined, calculated, or the like. In some exemplary embodiments, a selected distribution of the processing operations may be determined automatically based on user instructions, a determined complexity of a conversation of the user in the environment, a selected setting configuring the mode of the processing stage, an availability of separate devices, battery situations of the separate devices and the hearable devices, a communication latency or range between separate devices and/or the hearable devices, or the like. For example, in case a conversation of the user has a large number of participants (e.g., more than a threshold), the conversation may be determined to be complex, and the processing operations may be determined to be distributed to one or more separate devices, e.g., to a mobile device of the user.

In some exemplary embodiments, a selection regarding which processing operations should be performed by different devices (the hearable device and the at least one separate device), may be determined, calculated, or the like. For example, the selection may determine a speech separation technique to be applied on a noisy audio signal based on the resources required by the speech separation technique, an estimated latency that will be incurred by the speech separation technique, an estimated quality that will be provided by the speech separation technique, a level of complexity of the conversation, or the like. For example, processing operations may be selected in case they are estimated to comply with latency constraints such as having an overall delay threshold of five milliseconds (ms), ten ms, twenty ms, or the like. The decision how to distribute the processing operations may be made by the hearable, by a separate device, by a combination thereof, or the like. In some exemplary embodiments, precedence in the decision may be given to any of the devices, a majority voting may be performed, or the like. In some embodiments, the decision may be made in accordance with user settings.

In some exemplary embodiments, the processing operations that are distributed (unless a standalone mode is activated) may comprise applying speech separation on the noisy audio signal, cleaning speech segments from undesired sounds, applying filtration masks on the separate speech segments, applying audio compression or other DSP operations, or the like. In some exemplary embodiments, the processing operations that are distributed may comprise converting a captured noisy audio signal to a frequency domain, e.g., using an STFT operation. For example, a dongle may obtain audio signals as Pulse Density Modulation (PDM), and convert them to Pulse Code Modulation (PCM) before processing the signals or communicating them to be processed by other devices.

In some exemplary embodiments, speech separation may enable to extract a separate speech segment of a specific person in the user's environment, e.g., using an acoustic fingerprint of the person (or any other voice signature), a DoA of the person's voice, a general speech separation that may not utilize acoustic fingerprints, or the like. For example, a general speech separation may comprise source separation, a target speech separation, a blind source separation, background noise removal, or the like, during which unknown speakers may be automatically segmented and identified in audio. As another example, a sequence-to-sequence (seq2seq) model that is trained to receive as input an acoustic fingerprint and an audio signal may be utilized to extract speech that corresponds to the acoustic fingerprint from the audio signal. In some exemplary embodiments, the speech separation may be performed according to one or more methods with varying resource requirements and complexity levels, as disclosed in International Patent Application No. PCT/IL2023/050609, entitled “Processing And Utilizing Audio Signals”, filed Jun. 13, 2023.

In some exemplary embodiments, the speech separation may utilize acoustic fingerprints of one or more entities (e.g., a human entity, a non-human entity, or the like) for extracting voices of the entities. In some exemplary embodiments, acoustic fingerprints of entities may enable the identification of the voices of the entities in a noisy audio signal, without requiring further analysis of the noisy signal. In some exemplary embodiments, acoustic fingerprints may be generated automatically, manually, obtained from a third party, or the like. For example, acoustic fingerprints may be generated automatically based on vocal communications of the user with user contacts, vocal messages in the mobile device, instant messaging applications such as Whatsapp™, social network platforms, past telephone conversations of the user, synthesized speech, or the like. For example, an incidental or designated enrollment audio record, including an audio session of a target entity, may be utilized to generate an acoustic fingerprint of an entity. In some exemplary embodiments, an enrollment audio record may comprise an audio of the entity's sound that is a ‘clean’, e.g., has a minor background noise, has no background noise, is in a quiet environment, is known to belong to the entity, or the like.

In some exemplary embodiments, the speech separation may be performed based on general speech separation models that do not utilize acoustic fingerprints. For example, a general speech separation may utilize one or more separation techniques that do not require acoustic fingerprints, e.g., beamforming receiving array, audio source separation techniques, Finite Impulse Response (FIR) filter, Infinite Impulse Response (IIR) filter, Blind Signal Separation (BSS), Spectral Subtraction, Wiener Filtering, multi-channel Wiener filter, deep learning models such as Convolutional Neural Networks (CNNs) or Recurrent Neural Networks (RNNs), clustering algorithms, transformers, conformers, convolutional time-domain audio separation network, TF-GridNet, dual path RNN, or the like. For example, the general speech separation may be configured to output one or more audio signals associated with unknown speakers.

In some exemplary embodiments, after one or more processing operations are selected and the distribution thereof is determined, each assigned device may process one or more captured audio signals with their assigned processing operations. In some exemplary embodiments, the processed audio signals may be provided to a single device for the post-processing stage, e.g., to create an enhanced audio signal. For example, the processed audio signals may be provided to a single device via one or more communication means, such as Bluetooth™.

On Step 120, the enhanced audio signal may be generated and output to the user through the at least one hearable device. In some exemplary embodiments, the enhanced audio signal may be output, e.g., to hearables of the user, a conventional hearing aid device, a feedback-outputting unit, or the like. In some exemplary embodiments, the hearables may comprise a speaker associated with an earpiece, which may be configured to output, produce, synthesize, or the like, the enhanced audio signal. In some exemplary embodiments, the enhanced audio signal may comprise a combination of the separate speech segments, various background noises, or similar elements.

In some exemplary embodiments, the enhanced audio signal may be generated during the post-processing stage, during which processed audio signals may be obtained at a single device, e.g., the hearable devices, a separate device, or the like. It is noted that the hearable devices may constitute or be referred to as a single device, such as in case that they comprise two earbuds and a single processing unit. In some exemplary embodiments, the enhanced audio signal may be generated by combining different processed audio signals, synchronizing different processed audio signals, amplifying processed audio signals, attenuating processed audio signals, compressing different processed audio signals, introducing other changes, or the like. In some exemplary embodiments, different processed audio signals may have different latencies due to different processing times of different processing operations that are assigned to each device, potentially different communication times of the processed data, latencies intended to simulate a stereo effect (e.g., similarly to the method of FIG. 4), or the like.

In some exemplary embodiments, generating the enhanced audio signal may comprise obtaining one or more isolated speech segments of different entities, cleaning the speech segments from undesired sounds (e.g., using magnitude-only spectral-mapping, complex spectral-mapping, spectral masking, or the like), amplifying or attenuating the speech segments, enabling the user to adjust a volume of the background noise, combining speech segments, limiting an overall volume of a combined audio signal, applying a multi-band compressor, enabling the user to adjust one or more parameters, applying audio compression or other DSP operations, or the like. In some exemplary embodiments, the enhanced audio signal may enable the user to hear entities in their environment with an enhanced intelligibility, clarity, audibility, or the like.

In some exemplary embodiments, additional processing of the separate audio signals may comprise changing a pitch or tone of the separate speech segments, mapping the separate speech segments to higher or lower frequencies, changing a rate of speech of the separate speech segments (e.g., using phase vocoder or other learnable time stretching methods), introducing pauses or increased durations of pauses between words and/or sentences of the separate speech segments, or the like. In some exemplary embodiments, amplification may be accomplished digitally, such as by changing one or more parameters of the microphones, using a beamforming microphone array, or the like.

In some exemplary embodiments, the enhanced audio signal may be generated in

accordance with one or more ratios between separate audio signals, e.g., using one or more filtration masks. In some exemplary embodiments, a separate audio signal may be multiplied with a respective spectral mask, causing the enhanced audio signal to comprise a corresponding proportion of the separate audio signal. In some cases, a background noise may or may not occupy a certain ratio of the enhanced audio signal, e.g., as set by the user, defined by a default setting, or the like. For example, the enhanced audio signal may comprise 70% separated audio signals and 30% background noise (from which the separated audio signal may or may not be removed). The 70% may comprise 80% of a voice of a person, and 20% of a voice of a sound-of-interest such as a siren. In other cases, any other ratios may be used, selected, or the like. For example, the user may select to hear a ratio of one-third of the background noise and two-thirds of the separate audio signals.

In some exemplary embodiments, users may be enabled to adjust multiple settings of the enhanced audio signal, such as a proportion of the background noise that can be included in an output signal that is provided to the user's hearables, a volume of speech of each of the entities, or the like, thereby providing to the user full control of the output audio. For example, a volume of an entity may be adjusted using a filtration mask, or any other signal processing technique.

In some exemplary embodiments, in case the enhanced audio signal is generated at a separate device, and not at the hearable devices, the enhanced audio signal may be communicated to the at least one hearable device, e.g., to be outputted to the user thereby. In some exemplary embodiments, the hearable devices may convert the enhanced audio signal to sound waves, emitted by the one or more speakers to the user's ears. In some exemplary embodiments, the enhanced audio signal may be provided to hearables of the user, e.g., where the output signal may be reconstructed. In some exemplary embodiments, iterations of the flowchart of FIG. 1 may be performed continuously, such as to enable a conversation of the user to flow naturally.

Referring now to FIG. 2 showing an exemplary flowchart diagram, in accordance with some exemplary embodiments of the disclosed subject matter.

On Step 200, a first noisy audio signal may be obtained from an environment of the user, e.g., during a first timeframe. In some exemplary embodiments, the first noisy audio signal may be captured from an environment of a user by one or more microphones, e.g., periodically. In some exemplary embodiments, the environment of the user may comprise at least a second entity other than the user.

In some exemplary embodiments, the first noisy audio signal may be captured by at least one hearable device, e.g., similar to Step 100 of FIG. 1. In some exemplary embodiments, the first noisy audio signal may be captured by at least one hearable device that is used by a user for providing audio output to the user, e.g., using at least one microphone of the hearable device. In some exemplary embodiments, the first noisy audio signal may comprise at least a speech segment of the user (e.g., indicating that the user spoke during the capturing of the first noisy signal).

On Step 210, the first noisy audio signal may be processed locally on the at least one hearable device. In some exemplary embodiments, the first noisy audio signal may be processed at a single processing unit of the hearable device, at two or more processing units of the hearable device that communicate between one another, or the like.

In some exemplary embodiments, the first noisy audio signal may be processed by applying a first speech separation on the first noisy audio signal, e.g., in order to extract the first speech segment of the user. In some exemplary embodiments, the first speech separation may extract the user's voice from the first noisy audio signal by determining a direction of arrival of the user's speech, e.g., based on a default position of the at least one hearable device relative to the user. In some exemplary embodiments, the first speech separation may extract the user's voice from the first noisy audio signal based on an SNR of the first noisy audio signal (under the assumption that the user's voice will have the highest SNR in the signal). In some exemplary embodiments, the first speech separation may extract the user's voice from the first noisy audio signal by applying an acoustic signature of the user on the first noisy audio signals. In some exemplary embodiments, the first speech separation may extract the user's voice from the first noisy audio signal in any other manner.

In some exemplary embodiments, the direction of arrival of the user's voice may be determined based on a-priori knowledge of a relative location of the user with respect to the hearable device. For example, the hearable device may comprise a left-ear module and a right-ear module that may be configured to be mounted on a left ear and a right ear of the user, respectively. In some exemplary embodiments, the left-ear module may comprise at least a left microphone and a left speaker, and the right-ear module may comprise at least a right microphone and a right speaker. In some exemplary embodiments, a DoA of audio captured by the left microphone may be determined to match an approximate relative location of a mouth of the user with respect to the left ear of the user, and a DoA of audio captured by the right microphone may be determined to match an approximate relative location of the mouth of the user with respect to the right ear of the user, e.g., thereby determining the direction of arrival of the user's voice. In some exemplary embodiments, the direction of arrival of the user's voice may be determined in any other way, e.g., based on a beamforming receiver array, an array of directional microphones, a parametric model, a Time Difference of Arrival (TDoA) model, a data-driven model, a learnable probabilistic model, a manual indication obtained from a user, or the like. For example, the first noisy audio signal may be processed based on a-priori knowledge of a relative location of the first microphone with respect to the second microphone.

In some exemplary embodiments, the processing of the first noisy audio signal may incur a first delay. In some exemplary embodiments, the first delay may be incurred from applying the first speech separation, from communicating the first noisy audio signal from one or more microphones of the hearable device to a processing unit of the at least one hearable device, or the like.

On Step 220, a second noisy audio signal may be obtained, e.g., during a second timeframe. In some exemplary embodiments, the second timeframe may at least partially overlap with the first timeframe of the first noisy audio signal. In some exemplary embodiments, the second noisy audio signal may be obtained at one or more separate devices, at the same hearable device, or the like.

In some cases, the second noisy audio signal may be obtained at a separate device that is physically separate from the at least one hearable device. For example, the separate device may comprise a mobile device of the user, a dongle that is coupled to the mobile device, a case of the at least one hearable device, or any other computing device. In some exemplary embodiments, the processing operations may be performed at the separate device.

In some exemplary embodiments, the second noisy audio signal may be captured at the separate device, or captured at the hearable device and transmitted to the separate device. For example, at least a portion of the second noisy audio signal may be captured by at least one microphone of the separate device. According to this example, the second noisy audio signal may be different from the first noisy audio signal, but may be captured at a same or overlapping timeframes from the same environment. As another example, at least a portion of the second noisy audio signal may be captured by at least one microphone of the hearable device, and transmitted to the separate device. In such cases, the second noisy audio signal may comprise or be identical to the first noisy audio signal, extracted therefrom, or the like.

In some cases, the second noisy audio signal may be obtained and processed at the at least one hearable device. For example, the second noisy audio signal may be captured at the hearable device, or captured at one or more separate devices and provided for processing to the hearable device. In some exemplary embodiments, in case the second noisy audio signal is captured by microphones of the hearable device, the second noisy audio signal may comprise or be identical to the first noisy audio signal, may be extracted therefrom, or the like. For example, the second noisy audio signal may be identical to the first noisy audio signal. As another example, the second noisy audio signal may be extracted from the first noisy audio signal. In some exemplary embodiments, in case the second noisy audio signal is captured by microphones of a separate device and provided to the hearable device, the second noisy audio signal may be different from the first noisy audio signal, but may be captured at a same or overlapping timeframes from the same environment.

On Step 230, the second noisy audio signal may be processed, e.g., at the separate device, at the hearable device, or the like. In some exemplary embodiments, the processing stage may comprise applying a second speech separation on the second noisy audio signal to extract a second speech segment emitted by the second person. In some exemplary embodiments, the second speech separation may be applied on the second noisy audio signal to extract any other speech of any other person, e.g., target entities indicated by the user, entities for which acoustic fingerprints are available, or the like.

In some exemplary embodiments, the second noisy audio signal may be processed similar to Step 210. In some cases, the second speech separation may be configured to extract the second speech segment from the second noisy audio signal by utilizing the acoustic fingerprint of the second person for executing a first speech separation module. In such cases, the second speech separation may be configured to identify a direction of arrival of a speech of the second person, based on the identified second speech segment of the second person. In some exemplary embodiments, the second speech separation may be configured to perform the same or different processing for any other entity in addition to the second person. For example, after the second speech separation executes the first speech separation module, the second speech separation may be configured to execute a second speech separation module that utilizes the direction of arrival of speech from the second person and does not utilize the acoustic fingerprint of the second person, e.g., thereby reducing the computational resources that the second speech separation utilizes. In other cases, the second speech separation may utilize the acoustic fingerprint of the second person.

In some cases, the first speech separation may be executed over a single channel of captured audio, while the second speech separation may be executed over a plurality of channels of captured audio, e.g., three channels, according to an angle identified by the first speech separation, with or without utilizing the acoustic fingerprint of the second person. In some exemplary embodiments, the second speech separation module may utilize less resources than the first speech separation module, may have a smaller delay than the first speech separation module, or the like.

In some exemplary embodiments, the second speech separation may be performed based on a speech separation module that does not utilize any acoustic fingerprint, e.g., a general speech separation such as a source separation module. In such cases, the second speech separation may extract from the second noisy audio signal at least a first speech segment of the user and a second speech segment of the second person, e.g., since both voices may be present in the captured audio signal. In some cases, the second speech separation may be configured to remove, or refrain from adding, the first speech segment of the user from a generated audio signal prior to providing the generated audio signal for the post-processing stage. For example, the second speech separation may remove the first speech segment using an acoustic signature of the user, so that the speech segment of the user will not be communicated to the hearable device or to any other device performing the post-processing stage. In other cases, the second speech separation may not remove the first speech segment of the user from the generated audio signal, and the first speech segment of the user may be removed as part of the post-processing stage, e.g., based on the acoustic signature of the user. For example, the hearable device may be configured to remove the speech segment of the user from the enhanced audio signal based on an SNR of the speech segment of the user in the first noisy audio signal being above a threshold, being stronger than over voices, or the like. In some exemplary embodiments, the second speech separation may be configured to perform the same for any other entity in addition to the second person.

In some exemplary embodiments, the processing of the second noisy audio signal may incur a second delay greater than the first delay that was incurred by processing of the first noisy audio signal. In some exemplary embodiments, the second delay may be greater than the first delay since the second speech separation may be more complex, resource consuming, time consuming, or the like, compared to the first speech separation.

In some exemplary embodiments, the second delay may be greater than the first delay since the second speech separation may be applied to a greater number of entities than the first, e.g., human or non-human entities such as persons and/or background noise, than the first speech separation, thereby incurring additional computational costs. In some exemplary embodiments, in case the processing of the second noisy audio signal is performed at a separate device, the second delay may include a delay incurred from communicating the second speech segment from the separate device to the at least one hearable device.

In some exemplary embodiments, the first speech separation may utilize a first software module, and the second speech separation may utilize a second software module. In some embodiments, hardware or firmware modules may be used, alone or in combination with software modules. In some exemplary embodiments, the first software module may be configured to utilize less computational resources than the second software module. For example, the first speech separation may be performed without using an acoustic fingerprint of any entity, while the second speech separation may utilize acoustic fingerprints of one or more entities. According to this example, the first speech separation may require and utilize less computational resources for processing the first speech separation compared to the second speech separation. In other cases, using an acoustic fingerprint may utilize less resources than other speech separation techniques such as DoA tracking, e.g., depending on a context, on properties of different devices in the environment, or the like. In such cases, the first software module may utilize an acoustic fingerprint of the user, and the second speech separation may be performed without using an acoustic fingerprint of any entity. In some cases, the first software module may be configured to extract the first speech segment of the user based on an energy level or Root-Mean-Square (RMS) of the user in the first noisy audio signal, while the second speech separation may be configured to extract speech segments from the second noisy audio signal based on one or more acoustic fingerprints, e.g., the acoustic fingerprint of the second person, based on a DoA from the second person, or the like.

In other cases, the first and second software modules may comprise any other speech separation method, such that the first software module is estimated to utilize less resources than the second software module. In some cases, the first and second software modules may comprise a same software module, and the first software module may be estimated to utilize less resources than the second software module due to the second software module processing a greater number of voices of entities. For example, the first software module may apply an acoustic signature of the user, while the second software module may apply a plurality of acoustic signatures of a plurality of entities, e.g., including the second person, in order to identify with who the user is conversing and extract their voices.

On Step 240, based on the first and second speech segments, an enhanced audio signal may be generated and output to the user via the at least one hearable device. In some exemplary embodiments, the hearable device may convert the enhanced audio signal from a digital form to a pressure wave.

In some exemplary embodiments, a post-processing stage may be performed by one or more hearable devices, by a separate device, or the like, e.g., similar to Step 120 of FIG. 1, and may encompass applying noise cancellations, synchronizing processed data obtained from the first and second speech separation, combining the first and second speech segments, or the like. In some exemplary embodiments, the post-processing stage may generate an enhanced audio signal based on a time offset between the first and second noisy audio signals, e.g., by synchronizing the first and second speech segments accordingly.

In some exemplary embodiments, in case the post-processing stage is not performed at the hearable device, the enhanced audio signal may be transmitted to the hearable device to be outputted to the user. In some exemplary embodiments, the hearable device may comprise speakers and may be configured to convert the enhanced audio signal to audio waves, which may be outputted to the user using the speakers of the hearable device, e.g., independently of any speaker of a separate device. In some exemplary embodiments, the enhanced audio signal may enable the user to hear entities in their environment with an enhanced intelligibility, clarity, audibility, or the like.

In some cases, the hearable device may be configured to perform Active Noise Cancellation (ANC), passive noise cancellation, dereverberation algorithms, or the like, e.g., in order to reduce a collision between sounds in the environment and a delayed version of the sounds in the enhanced audio signal.

In some exemplary embodiments, in case the second person speaks at a first timepoint, and the user speaks at a second timepoint that is later than the first timepoint, the enhanced audio signal may be provided to the user at a third timepoint that is later than the second timepoint, such that a time lag between the first timepoint and the third timepoint is longer than a time lag between the second timepoint and the third timepoint. In other cases, the enhanced audio signal may be provided to the user at any other timeframe, e.g., before the second timepoint.

Referring now to FIG. 3 showing an exemplary flowchart diagram, in accordance with some exemplary embodiments of the disclosed subject matter.

On Step 300, a complexity score of a conversation in which the user participates may be computed. For example, the complexity score may be computed based upon a segment of the conversation captured for assessing the complexity score. In some exemplary embodiments, the user may take part in a conversation with one or more other entities, people, or the like, within an environment. In some exemplary embodiments, the user may utilize at least one hearable device (such as two earbuds) for providing audio output to the user, e.g., conveying to the user sounds from the conversation.

In some exemplary embodiments, the complexity score of the conversation may be determined, calculated, or the like, based on an SNR of the conversation, an SNR of an overall sound in the environment, an intelligibility level of the conversation, a confidence score of a speech separation module, an estimated distance of the user from the target speaker, a number of participants in the conversation, or the like.

In some exemplary embodiments, the complexity score of the conversation may depend on an overlap between audio frequencies of the conversation and audio frequencies of background noise in the environment. In some exemplary embodiments, the complexity score of the conversation may depend on a frequency range of background noise in the environment. In some exemplary embodiments, the complexity score of the conversation may depend on a monotonic metric of background noise in the environment, the monotonic metric measuring how much the background noise is monotonic. For example, as the monotonic metric increases, the complexity score may be reduced. In some exemplary embodiments, the complexity score of the conversation may depend on a similarity measurement of two or more voices in the environment that are emitted by two or more separate entities. For example, the complexity score of the conversation may depend on a similarity measurement between a first acoustic fingerprint of a first entity and a second acoustic fingerprint of a second entity, in case the first and second entities participate in the conversation. In some exemplary embodiments, the higher the similarity between the acoustic fingerprints, the higher the complexity score may be (e.g., defining a monotonic correlation).

In some exemplary embodiments, the complexity score of the conversation may be determined during short, mid, or long timeframes. For example, a timeslot of 10 ms, 100 ms, 1 minute, 2 minutes, or the like, may be used to capture audio channels from the user's environment and determine a respective complexity score.

On Step 310, a computation modality for the conversation may be selected based on the complexity score, thereby obtaining a selected computation modality. In some exemplary embodiments, the computation modality may comprise an indication of sets of processing operations that should be performed, and a distribution of the processing operations to one or more devices. In some exemplary embodiments, the computation modality may comprise an indication of a level of resources that may be used for the processing stage, as well as latency levels that each computation must comply with. For example, the computation modality may include a determined level such as ‘simple’, ‘intermediate’, and ‘complex’, each of which is associated with one or more levels of resource consumptions, latencies, or the like. For example, each computation modality may be associated with a respective set of one or more speech separation modules.

In some exemplary embodiments, the computation modality may be selected by comparing the complexity score with a complexity threshold. In some exemplary embodiments, in case the complexity score of the conversation is lesser than the complexity threshold, a first speech separation may be selected to be applied to the noisy audio signal. In some exemplary embodiments, responsive to the complexity score of the conversation exceeding the complexity threshold, a second speech separation may be selected to be applied to the noisy audio signal. In some exemplary embodiments, the first speech separation may utilize less resources than the second speech separation. In some cases, the first speech separation may be expected to result with a first delay between the capturing of a noisy audio signal and the outputting of an enhanced signal based thereon, while the second speech separation may be expected to result with a second, greater, delay.

In one scenario, the second speech separation may be configured to separate speech based on acoustic fingerprints of participants participating in the conversation, and the first speech separation may not utilize any acoustic fingerprint for speech separation, e.g., thereby using less computational resources. For example, the first speech separation may be configured to separate speech based on direction of arrival calculations of the participants, and the second speech separation may be configured to separate speech based on acoustic fingerprints of participants participating in the conversation.

In some exemplary embodiments, the computation modality may indicate a processing distribution of any one or more of the pre-processing stage (e.g., the capturing stage), the processing stage, the post-processing stage, or the like. For example, the computation modality may indicate that the first speech separation should be performed at a first device, and the second separation should be performed at a second device. In some exemplary embodiments, the first or second devices may comprise a mobile device of the user, a dongle that is configured to be coupled to the mobile device of the user, a case for storing the at least one hearable device, the at least one hearable device, or the like.

In some exemplary embodiments, the processing distribution may be determined based on the complexity score, based on a comparison of the complexity score with a complexity threshold, or the like. For example, complex computations of the processing stage may be distributed to a separate device, while simple computations may be distributed to the hearable device. In some exemplary embodiments, in case the complexity score of the conversation is lesser than the complexity threshold, the processing stage may be selected to be performed by the at least one hearable device, while in case the complexity score of the conversation exceeds the complexity threshold, the processing stage may be selected to be performed by a separate device that is physically separate from the at least one hearable device, e.g., a case, mobile device, or the like. For example, the computation modality may indicate that speech separation should be applied on the noisy audio signal at a mobile device of the user. As another example, the computation modality may indicate that speech separation should be applied on the noisy audio signal by a processor embedded in a case in which the at least one hearable device is configured to be stored. As another example, the computation modality may indicate that speech separation should be applied using a processor embedded in the at least one hearable device. As another example, the computation modality may indicate that speech separation should be applied by two or more devices simultaneously, e.g., the hearable device and one or more separate devices.

On Step 320, a noisy audio signal may be captured from the environment, e.g., similar to Step 100 of FIG. 1. In some cases, in case the computation modality indicates a distribution of the pre-processing stage, the noisy audio signal may be captured from the environment according to the indicated distribution. For example, in case the computation modality indicates that the pre-processing stage should be performed at a separate device, the separate device may capture the noisy audio signal.

On Step 330, the noisy audio signal may be processed according to the selected computation modality, e.g., similarly to the processing of Step 110 of FIG. 1, in order to generate an enhanced audio signal.

In some exemplary embodiments, the noisy audio signal may be processed by applying a speech separation module indicated by the computation modality at one or more locations indicated by the computation modality. In some exemplary embodiments, the noisy audio signal may be processed by applying one or more speech separation modules that comply with a level of resources associated with the computation modality, that comply with a location of processing indicated by the computation modality, or the like. For example, a set of speech separation modules may be applicable to a selected computation modality (e.g., a ‘simple’ modality), and one of them may be selected and used for the processing stage.

On Step 340, the enhanced audio signal may be outputted to the user via the at least one hearable device, e.g., similar to Step 120 of FIG. 1.

In some cases, concurrently and/or subsequently to outputting the enhanced audio signal to a user, one or more subsequent noisy audio signals may be captured and processed, e.g., according to Steps 320-340. For example, Steps 320-340 may be performed iteratively using the same selected computation modality.

In some exemplary embodiments, the computation modality may be adjusted. In some cases, subsequently to outputting the enhanced audio signal to a user, a second complexity score of the conversation in which the user participates may be determined, adjusted, or the like. For example, the second complexity score may be determined in case that a context of the conversation changes, e.g., a number of participants in the conversation is determined to change significantly, a volume of the conversation changes, or the like. As another example, the complexity score may be adjusted or calculated periodically. In some exemplary embodiments, the second complexity score may be different from the first complexity score. In some exemplary embodiments, a second computation modality, different from the first computation modality, may be selected for the conversation based on the second complexity score. For example, the first computation modality may utilize a first speech separation that is expected to result with a first delay, and the second selected computation modality may utilize a second speech separation that is expected to result with a second, greater, delay. As another example, the first computation modality may utilize the at least one hearable device for processing captured audio signals, while the second selected computation modality may utilize a separate device for processing captured audio signals.

In some exemplary embodiments, one or more second noisy audio signals may be captured from the environment and processed according to the second selected computation modality. In some exemplary embodiments, the resulting enhanced audio signals may be outputted to the user via the at least one hearable device.

Referring now to FIG. 4 showing an exemplary flowchart diagram, in accordance with some exemplary embodiments of the disclosed subject matter.

On Step 400, a noisy audio signal may be captured from an environment of a user, by an array of two or more microphones, e.g., similar to Step 100 of FIG. 1. In some exemplary embodiments, the noisy audio signal may comprise a speech segment of a target person different from the user, such as a person with which the user is conversing.

In some exemplary embodiments, the user may utilize at least one hearable device comprising a first hearing module and a second hearing module, e.g., right ear and left ear earbuds. In some exemplary embodiments, the first hearing module may be a left-ear earbud having embedded thereon a first microphone and a left-ear speaker, and the second hearing module may be a right-ear earbud having embedded thereon a second microphone and a right-ear speaker. In some exemplary embodiments, the left-ear earbud may be configured to be mounted on a left ear of the user, and the right-ear earbud may be configured to be mounted on a right ear of the user.

In some exemplary embodiments, the environment may comprise an array of two or more microphones for capturing noisy audio signals. For example, the array may capture speech segments of the conversation between the user and the target entity. In some exemplary embodiments, the array of two or more microphones may be mounted on the first and second hearing modules, e.g., on the right-ear earbud and left-ear earbud. For example, a first set of a plurality of microphones may be embedded in the left-ear earbud, and a second set of a plurality of microphones may be embedded in the right-ear earbud.

In some exemplary embodiments, the array of two or more microphones may be mounted on a separate device that is physically separate from the at least one hearable device, e.g., a dongle, case of hearables, mobile device, or the like.

On Step 410, based on the noisy audio signal, a stereo audio signal may be generated. In some exemplary embodiments, the stereo audio signal may be configured to simulate a directionality of sound as if the stereo audio signal is provided to the user from the target person, and not from the array.

In some exemplary embodiments, the stereo audio signal may be generated to include a first audio signal for the first hearing module of the hearable devices, and a second audio signal for the second hearing module of the hearable devices. For example, the first and second audio signals represent at least a speech segment of the target person.

In some exemplary embodiments, the noisy audio signal may be processed at a single processing unit, in order to ensure full synchronization between the first and second audio signals. For example, the processing unit may implement at least a portion of a processing stage, e.g., by applying a speech separation to the noisy audio signal. In some exemplary embodiments, the processing unit may be embedded within the at least one hearable device, within at least one separate device that is physically separate from the at least one hearable device (e.g., a mobile device of the user), or the like. In case that the microphone array is mounted on both hearable devices, the captured audio signals may be communicated between the first and second hearing modules for processing. In case that the microphone array is mounted on a separate device, the captured audio signals may be processed by determining a direction of arrival of the noisy audio signal at the separate device. In case the processing unit is separate from a capturing device that includes that array of microphones, the capturing device may provide captured audio channels to the processing unit via one or more communication mediums.

In some exemplary embodiments, the stereo audio signal may be generated by injecting a determined delay into one of the first and second audio signals, e.g., designated for the user's left or right ear, and not into the other audio signal. For example, the delay may be injected into the second audio signal without injecting the delay into the first audio signal, e.g., in case that the target person is in closer proximity to the first hearing module than to the second hearing module, and vice versa. The injected delay may cause an effect of directionality that imitates the angle between the user and the target entity, making the sound be perceived as reaching the user from the direction of the target entity. In some embodiments, delays may be injected to both the first and second audio signals, such that an insignificant first delay that is small enough to not be noticed by the user is injected into either the first and second audio signals, and a significant second delay is injected to the other audio signal so that the user will notice the second delay, thereby preserving the sense of directionality. For example, the second delay may comprise an increased delay that is augmented with the determined delay, compared to the first delay. In other cases, the second delay may comprise an increased delay that is augmented with any other delay.

In some exemplary embodiments, in order to generate the stereo audio signal, a distance between the target entity and the user, and an angle between them, may be determined. In some exemplary embodiments, an angle between the target entity and the user may be determined based on a first angle between the axis connecting the array of two or more microphones and between the line of sight of the user, and based on a second angle between the axis connecting the target person and the array of two or more microphones, and between the line of sight of the target person.

In some exemplary embodiments, the first and second angles may be determined based on one or more beamforming techniques, triangulations, a-priori knowledge of positions of arrays and devices, or the like, and may be used for determining the delay.

For example, the first angle may be calculated in case the array is mounted on the hearable devices, based on a-priori knowledge of relative locations. In such cases, a direction of arrival of a first noisy audio signal captured by the first microphone of the hearable device may be determined according to a relative location of a mouth of the user with respect to the left ear of the user, and a direction of arrival of a second noisy audio signal captured by the second microphone of the hearable device may be determined according to a relative location of the mouth of the user with respect to the right ear of the user.

On Step 420, the stereo audio signal may be outputted to the user, via the at least one hearable device. For example, the stereo audio signal may be converted from digital to acoustic energy to be emitted by speakers of the hearable device. In some exemplary embodiments, outputting the stereo signal may cause the first audio signal to reach the first hearing module before the second audio signal reaches the second hearing module, thereby simulating the directionality of sound.

Referring now to FIG. 5 showing an exemplary environment in which the disclosed subject matter may be utilized, in accordance with some exemplary embodiments of the disclosed subject matter.

In some exemplary embodiments, Environment 500 may comprise Hearables 540, which may comprise one or more hearable devices such as headphones, wired earplugs, wireless earplugs, a Bluetooth™ headset, a bone conduction headphone, electronic in-ear devices, in-ear buds, or the like. In some exemplary embodiments, Hearables 540 may comprise an array of one or more microphones (e.g., one microphone on each earplug), one or more speakers, a communication unit, a processing unit, or the like.

In some cases, the array of microphones of Hearables 540 may comprise a multi-port microphone for capturing multiple audio signals. In some cases, the array of microphones of Hearables 540 may comprise a single microphone in each hearable device, a plurality of microphones in each hearable device, or the like. In some exemplary embodiments, the array of microphones of Hearables 540 may comprise one or more microphone types. For example, the microphones may comprise directional microphones that are sensitive to picking up sounds in certain directions, unidirectional microphones that are designed to pick up sound from a single direction or small range of directions, bidirectional microphones that are designed to pick up sound from two directions, cardioid microphones that are sensitive to sounds from the front and sides, omnidirectional microphones that pick up sound with equal gain from all sides or directions, or the like. In some exemplary embodiments, the array of microphones of Hearables 540 may iteratively capture audio signals with a duration of 5 milliseconds (ms), 10 ms, 20 ms, 30 ms, or the like. In some exemplary embodiments, the number of channels captured by the array may correspond to a number of microphones in the array.

In some exemplary embodiments, the array of microphones of Hearables 540 may perform beamforming for improving the SNR of captured audio, e.g., based on Digital Signal Processing (DSP). In some cases, Hearables 540 may integrate one or more sensors such as accelerometers or gyroscopes to enhance a directionality tracking of different sounds. In some cases, the user's head position may be sensed by the hearables, e.g., via sensors, and used to automatically point the microphone array to the direction of the head's position.

In some cases, the processing unit of Hearables 540 may comprise one or more integrated circuits, microchips, microcontrollers, microprocessors, one or more Central Processing Unit (CPU) portions, Graphics Processing Unit (GPU), Digital Signal Processing (DSP), Field-Programmable Gate Array (FPGA), Inertial Measurement Unit (IMU), or other circuits suitable for executing instructions or performing logic operations.

In some exemplary embodiments, the processing unit may comprise any physical device having an electric circuit that performs a logic operation on input or inputs. The instructions executed by the processing unit may, for example, be pre-loaded into a memory that is integrated with the processing unit, pre-loaded into a memory that is embedded into the processing unit, may be stored in a separate memory, or the like. In some exemplary embodiments, the processing unit may be integrated with Hearables 540. In some cases, the processing unit may comprise a portable device that may be mounted or attached to the hearables.

In some cases, the communication unit of Hearables 540 may enable Hearables 540 to communicate with one or more separate devices in Environment 500. In some exemplary embodiments, Environment 500 may comprise one or more separate devices such as a Mobile Device 520, a Dongle 522, Case 510, or the like, with which Hearables 540 may communicate. In some cases, the communication unit of Hearables 540 may enable Hearables 540 to communicate with one another. For example, a first hearable device of Hearables 540 may be enabled to communicate with a second hearable device of Hearables 540, e.g., using one or more communication protocols such as Low Energy (LE)-audio, Bluetooth, or the like. In some cases, inter-device communication between earphone units of Hearables 540 may enable the earphones to communicate therebetween, transmit and receive information such as audio signals, coordinate processing and transmission to the user, or the like.

In some exemplary embodiments, communication facilitated by the communication unit may be performed via a communication medium such as Medium 505. For example, Medium 505 may comprise a wireless and/or wired network such as, for example, a telephone network, an extranet, an intranet, the Internet, satellite communications, off-line communications, wireless communications, transponder communications, a local area network (LAN), a wide area network (WAN), a virtual private network (VPN), or the like. In some exemplary embodiments, Medium 505 may utilize various wireless standards such as Wi-Fi, Bluetooth™, LE-Audio, or the like, or similar technologies such as near-field capacitive coupling, short range wireless techniques, physical connection protocols such as Lightning™, or the like. In some exemplary embodiments, Medium 505 may comprise a shared, public, or private network, a wide area network or local area network, and may be implemented through any suitable combination of wired and/or wireless communication networks. In some exemplary embodiments, Medium 505 may comprise one or more short range or near-field wireless communication systems.

In some exemplary embodiments, Medium 505 may enable communications between Mobile Device 520, Dongle 522, Case 510, Hearables 540, or the like. In some cases, Medium 505 may enable communications between Server 530 and Hearables 540, one or more separate devices, or the like.

In some exemplary embodiments, one or more communication units or processing units similar to those in Hearables 540 may be embedded in separate devices such as Mobile Device 520, Dongle 522, Case 510, or the like. For example, communication units of Mobile Device 520 and Dongle 522 may enable to communicate raw or processed audio signals between Mobile Device 520 and Dongle 522 via a lightning connector protocol, a USB Type-C (USB-C) protocol, or any other protocol (e.g., depending on the properties of Mobile Device 520). As another example, communication units of Hearables 540 and Dongle 522 may enable to communicate raw or processed audio signals between Hearables 540 and Dongle 522 via a Low Energy (LE)-audio protocol, any other Bluetooth™ communication protocol, or the like.

In some cases, one or more sensors such as accelerometers or gyroscopes may be integrated in one or more separate devices such as Mobile Device 520, Dongle 522, Case 510, or the like, and may be used to extract signals, events, or the like. For example, an accelerometer embedded within Mobile Device 520 may be used to determine whether Mobile Device 520 is parallel to the ground, which may affect one or more calculations. For example, according to this example, a selection between speech separation modules may be made based on whether Mobile Device 520 is parallel to the ground, e.g., such that a beamformer-based module for determining DoA of a voice will not be used in case that Mobile Device 520 is not parallel to the ground. Instead, other speech separation modules may be used, e.g., acoustic signature based modules.

In some exemplary embodiments, Mobile Device 520 may comprise a mobile device of the user such as a smartphone, a Personal Computer (PC), a tablet, an end device, or the like. In some exemplary embodiments, Mobile Device 520 may comprise one or more communication units, processing units, microphone arrays, or the like. For example, an array of one or more microphones may be mounted on Mobile Device 520. In some cases, Mobile Device 520 may execute a dedicated software application for controlling Hearables 540, for retrieving acoustic fingerprints, or the like. In some exemplary embodiments, Mobile Device 520 may enable the user to provide user input, obtain information, control provided audio, change settings, or the like, e.g., via the dedicated software application.

In some exemplary embodiments, Dongle 522 may comprise an extension piece of Mobile Device 520 that may be connectable to and retractable from Mobile Device 520. In some exemplary embodiments, Dongle 522 may comprise one or more communication units, processing units, microphone arrays, or the like. For example, beamformer microphones may be mounted on Dongle 522 in a non-collinear fixed position relative to each other. In some exemplary embodiments, Dongle 522 may have a width that corresponds to half of the width of Mobile Device 520, a quarter thereof, or the like.

In one embodiment, Dongle 522 may comprise a microphone array with or without a processor, and may communicate any captured audio signals to Mobile Device 520 (or any other device) for any processing to be performed. For example, Dongle 522 may obtain audio signals as Pulse Density Modulation (PDM), and then convert them to Pulse Code Modulation (PCM) before communicating the signals to other devices for processing. In another embodiment, the dongle may comprise a microphone array and a processing unit. In case Dongle 522 has its own processing unit, Dongle 522 may process signals in their original PDM form, which may be more accurate for beamforming than the PCM form.

In some exemplary embodiments, Case 510 may comprise a case for storing and/or charging Hearables 540. For example, Case 510 may comprise an indentation for storing a left-ear hearable device, an indentation for storing a right-ear hearable device, or the like. In some cases, Case 510 may comprise an earphone case used for storing Hearables 540 when not in use and for charging them. In some exemplary embodiments, Case 510 may comprise one or more charging units, communication units, processing units, microphone arrays, or the like. For example, an array of one or more microphones may be mounted on Case 510.

In some exemplary embodiments, one or more microphone arrays corresponding to the array of microphones of Hearables 540 may be mounted over or embedded within one or more separate devices, e.g., Mobile Device 520, Dongle 522, Case 510, or the like.

In some cases, the microphone arrays may comprise a plurality of microphones, which may be strategically placed in one or more separate devices to capture sounds from different sources or locations. In some exemplary embodiments, the microphone arrays may comprise arrays of one or more microphones on each device, on a subset of the devices, or the like. For example, arrays of at least two microphones may be mounted on each separate device, e.g., thereby enabling each separate device to capture a directionality of sound waves.

In some cases, a microphone array may be mounted on two or more devices, while functioning as a single array that can capture a directionality of sounds. For example, a first microphone on a first device and a second microphone on a second device may, together, function as a directional array that enables the first and second devices to capture a directionality of sound waves. For example, a first microphone of Mobile Device 520 and a second microphone of Dongle 522 may together constitute a microphone array that can capture a directionality of sound waves, e.g., in case of a known relative location between Mobile Device 520 and Dongle 522. As another example, a first microphone of Case 510 and a second microphone of Hearables 540 may together constitute a microphone array that can capture a directionality of sound waves.

In some exemplary embodiments, the microphone arrays of the separate devices, Hearables 540, or the like, may capture one or more noisy audio signals in an environment of the user, as part of a pre-processing stage. In some exemplary embodiments, during a processing stage, the one or more noisy audio signals may be processed, synchronized, combined, or the like. In some exemplary embodiments, during a post-processing stage, processed audio signals may be converted from digital to acoustic energy and emitted to the user via Hearables 540. In some exemplary embodiments, one or more processing operations of the processing stage may be distributed between Hearables 540, Mobile Device 520, Dongle 522, Case 510, or the like. For example, all the processing operations of the processing stage may be performed externally to Hearables 540. As another example, all the processing operations of the processing stage may be performed within Hearables 540. As another example, some processing operations of the processing stage may be performed within Hearables 540, and some processing operations may be performed externally to Hearables 540, e.g., by Mobile Device 520, Dongle 522, Case 510, or the like.

In some exemplary embodiments, during the processing stage, one or more processing operations may be performed. For example, each audio channel that is captured may be processed (e.g., separately) by a Short-Time Fourier Transform (STFT) transformation, Auto Gain Control, audio filters, or the like. In some cases, two or more audio channels may be filtered together, each audio channel may be filtered independently, or the like. As another example, one or more audio channels may be processed or enhanced by applying a Multi Band (MB) compressor, applying an audio equalization technique, or the like. As another example, one or more audio channels may be processed by applying thereon DSPs, equalizers, limiters, time stretchers, signal smoothers, or the like. For example, DSPs such as high-pass filters, low-pass filters, notch filters, or the like, may be utilized to reduce or filter out a reverberation effect or other undesired signals from the audio signals.

In some exemplary embodiments, during the processing stage, speech separation may be performed by one or more processing units, e.g., on one or more locally captured audio signals, one or more audio signals captured elsewhere and communicated to the processing unit, or the like. In some exemplary embodiments, speech separation may be utilized to extract separate audio signals of entities in the environment. In some cases, speech separation may be more efficient on devices such as Mobile Device 520, Dongle 522, and Case 510, compared to applying speech separation by Hearables 540, e.g., since these devices may be in closer proximity to participants in the user's conversation compared to Hearables 540.

In some exemplary embodiments, one or more channels of the noisy audio signal (e.g., captured by respective microphones) may be provided to a processing unit. In some exemplary embodiments, in case the processing unit is housed in a same device as the capturing microphones, the captured noisy audio signal may be provided to the processing unit via inter-device communications. For example, the captured noisy audio signal may be provided via a lightning connector protocol, a USB Type-C (USB-C) protocol, an MFI connector protocol, or any other protocol. In some exemplary embodiments, in case the processing unit is housed in a different device from the microphones, the captured noisy audio signal may be transferred to the processing unit via a short distance communication, or any other transmission that is configured for communication between separate devices.

In some exemplary embodiments, the processing unit may transform the channels from the time domain to a frequency domain (e.g., using a Short-Time Fourier Transform (STFT) operation or any other operation), and apply a speech separation thereon, such as in order to extract voices associated with acoustic signatures from the noisy audio signal. For example, acoustic signatures of known contacts may be stored in a database, unknown signatures may be created on-the-fly during the conversation, or the like. In some exemplary embodiments, the speech separation model may use a generative model to generate and output audio signals of the separated voices or spectrograms thereof. In some cases, the speech separation model may use a machine learning model that is trained to map or learn a mapping between the noisy input and a corresponding clean output. In some exemplary embodiments, the speech separation model may utilize a discriminative mask model that is multiplied by the input to filter out undesired audio.

In some exemplary embodiments, a distribution of processing operations of the processing stage may be determined for the user and for other entities. For example, the distribution may allocate a speech separation of the user's voice to Hearables 540, and a speech separation of other voices to one or more separate devices such as Mobile Device 520, Dongle 522, and Case 510. As another example, the distribution may select a first speech separation for processing the user's voice, and a second speech separation (e.g., that utilizes more resources) for processing voices of other entities. In some exemplary embodiments, the distribution may correspond to the method of FIG. 2.

In some exemplary embodiments, a distribution of processing operations of the processing stage may be determined according to a complexity score of the situation. For example, the distribution may allocate simple tasks to Hearables 540, and complex tasks to one or more separate devices such as Mobile Device 520, Dongle 522, and Case 510. In some exemplary embodiments, the distribution may correspond to the method of FIG. 3.

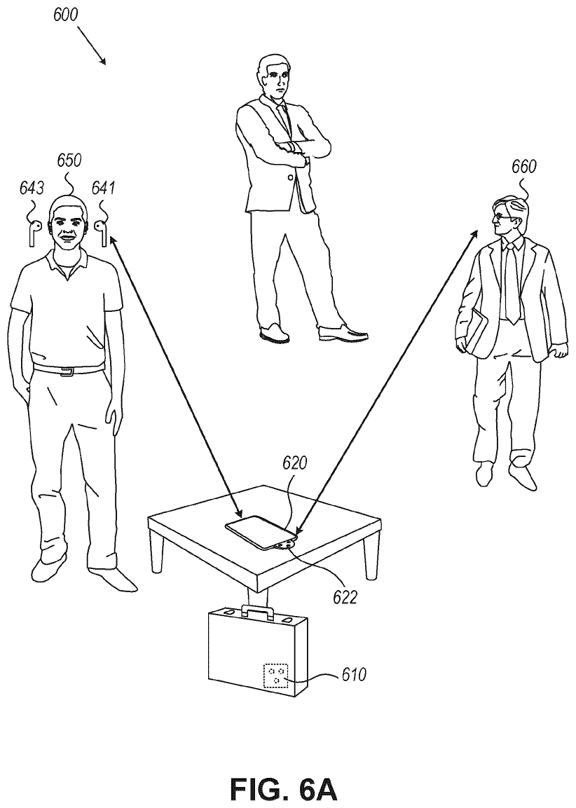

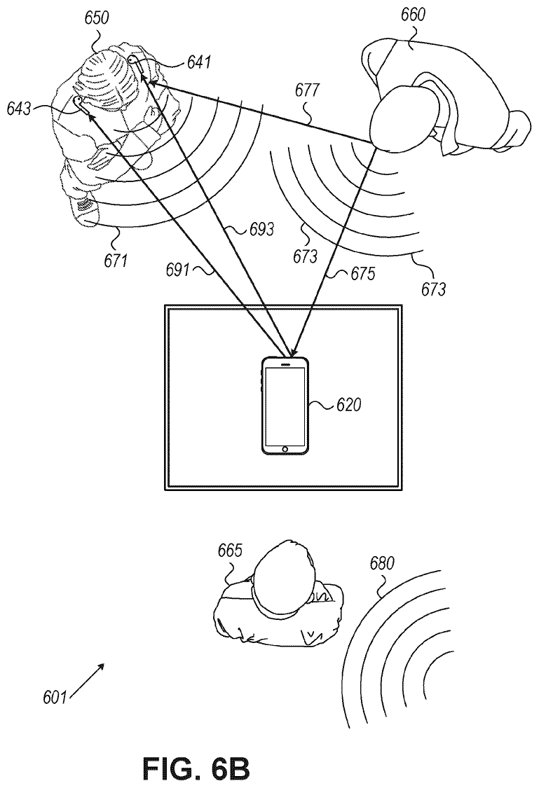

In some exemplary embodiments, after each device performs its allocated processing operations, it may communicate the resulting processed audio signals to a single device such as Hearables 540 (considered a single device even if Hearables 540 comprises two hearables), directly or via other devices. For example, a processed audio signal may be communicated from Dongle 522 to Hearables 540 via LE-Audio transmissions. In some cases, the processing operations may correspond, at least in part, to the processing of FIG. 6B in International Patent Application No. PCT/IL2023/050609, entitled “Processing And Utilizing Audio Signals”, filed Jun. 13, 2023.

In some exemplary embodiments, one or more post-processing operations may be performed, e.g., by Hearables 540, such as combining and synchronizing obtained processed audio signals that are obtained from different sources, ensuring that the volume of accumulated sounds is not greater than a threshold (e.g., a Maximal Possible Output (MPO)), applying Inverse STFT (ISTFT) in order to convert the signal back from the frequency domain to the time domain, applying a Multi Band (MB) compressor, applying a Low Complexity Communication Codec (LC3) compressor, applying any other audio compression, applying one or more of wrapping the signal, DSPs, Pulse-Code Modulations (PCMs), equalizers, limiters, signal smoothers, performing one or more adjustment to a preset of audiogram settings of the user, or the like.

In some exemplary embodiments, the post-processing operations may comprise generating two audio signals for two earbuds of Hearables 540, and injecting a delay into at least one of them, e.g., according to the method of FIG. 4. For example, this may enable to maintain a directionality in the generated audio signals.

In some exemplary embodiments, Hearables 540 may obtain the generated audio signals, e.g., via Medium 505, via inter-device communication, or the like. Hearables 540 may convert the audio signals from digital to acoustic energy, synthesize them, or the like. For example, the audio signals may be converted to sound waves and played to the user. In some exemplary embodiments, Hearables 540 may mix low latency audio encompassing the user's voice with higher latency audio encompassing sounds of other entities, so that the user's voice will be provided with lower latency than the other sounds. In some cases, Hearables 540 may provide an Application Program Interface (API) through which the processed audio may be obtained and played for the user.

In some cases, Server 530 may be omitted from the environment, or may be used to provide acoustic fingerprints, to perform offline computations, or the like.

Referring now to FIG. 6A showing an exemplary environment in which the disclosed subject matter may be utilized, in accordance with some exemplary embodiments of the disclosed subject matter.

In some exemplary embodiments, Environment 600 may comprise one or more hearable devices, e.g., Hearables 641 and 643. For example, Hearables 641 and 643 may correspond to left and right ear modules of Hearables 540 of FIG. 5. In some exemplary embodiments, Environment 600 may comprise one or more separate devices, e.g., Case 610, Mobile Device 620, and Dongle 622. For example, Case 610, Mobile Device 620, and Dongle 622 may correspond to Case 510, Mobile Device 520, and Dongle 522 of FIG. 5, respectively. In some cases, only a subset of the separate devices may be present in Environment 600.

In some exemplary embodiments, Environment 600 may comprise a user, e.g., User 650, which may utilize Hearables 641 and 643 for obtaining audio output. In some exemplary embodiments, User 650 may interact or converse with one or more entities, such as with Person 660.

In some exemplary embodiments, in accordance with the method of FIG. 1, audio signals from Environment 600 may be captured by one or more microphone arrays, and processed by one or more devices of User 650: Hearables 641 and 643, Case 610, Mobile Device 620, Dongle 622, or the like. For example, a microphone array of Dongle 622 may capture a noisy audio signal from Environment 600, including voices of User 650, Person 660, or the like. According to this example, Dongle 622 may communicate the noisy audio signal to Mobile Device 620 for further processing, such as for applying speech separation. Mobile Device 620 may extract a speech segment of Person 660, process it (e.g., by amplification), and provide an enhanced audio signal based thereon to Hearables 641 and 643.

In some exemplary embodiments, in accordance with the method of FIG. 2, the voice of User 650 may be processed separately from the voice of Person 660. Alternatively, the voice of User 650 may not be extracted and processed at all. For example, Hearables 641 and 643 may process the voice of User 650, while Mobile Device 620 may process the voice of Person 660 (e.g., using a more complex speech separation than Hearables 641 and 643). As another example, Hearables 641 and 643 may process the voice of User 650 using a first audio processing module, and the voice of Person 660 using a second audio processing module. In some exemplary embodiments, Hearables 641 and 643 may extract the voice of User 650 from a noisy audio signal that is captured locally by microphones of Hearables 641 and 643, from a noisy audio signal that is captured elsewhere (e.g., at Dongle 622) and communicated to Hearables 641 and 643, or the like.

In some exemplary embodiments, in accordance with the method of FIG. 3, the computation modality of Environment 600 may be determined based on a complexity score. For example, in case User 650 converses only with Person 660, and there is no strong background noise, in case of energetic masking, or the like, the complexity score may be low, and a computation modality may be selected such that the capturing stage and the processing stage of all entities may be scheduled to be performed by Hearables 641 and 643, e.g., using either simple or complex speech separation techniques. In case of a higher complexity score, such as in case more people are conversing with User 650, in case of informatic masking, in case of strong background noise, in case of low SNR, or the like, a computation modality may be selected such that the capturing stage and the processing stage may be at least partially distributed to separate devices such as Case 610, Mobile Device 620, Dongle 622, or the like.

In some exemplary embodiments, in accordance with the method of FIG. 4, Mobile Device 620 may generate an enhanced audio signal that replicates the original directionality of the voice of Person 660 with respect to User 650, such that the enhanced audio signal imitates the direction of audio waves emitted from Person 660 to User 650. For example, Mobile Device 620 may generate two audio signals, one for Hearable 641 and one for Hearable 643, and inject a noticeable delay (e.g., a significant delay that can be noticed by users) solely into the signal for Hearable 643. In some cases, by injecting a delay to an audio signal designated to Hearable 643, User 650 may perceive the sound as arriving from a direction of Hearable 641, which may correspond to the direction of Person 660. This may cause User 650 to perceive the enhanced audio signal as a stereo signal with directionality matching the angle between Person 660 and User 650. In some cases, the method of FIG. 4 may be implemented according to the scenario of FIG. 6B.

Referring now to FIG. 6B showing an exemplary environment in which the disclosed subject matter may be utilized, in accordance with some exemplary embodiments of the disclosed subject matter.

In some exemplary embodiments, Environment 601 may correspond to Environment 600. In some exemplary embodiments, Environment 601 may comprise User 650, Person 660, and a Second Person 665, engaged in a conversation with one another. In some exemplary embodiments, Sounds 671 may be emitted by User 650 during the conversation, and Sounds 673 may be emitted by Person 660 during the conversation. In some exemplary embodiments, one or more background noises such as Sounds 680 may be emitted to Environment 601 by one or more human and/or non-human entities such as other conversations, monotonic sounds of an air conditioner, sounds of traffic, or the like.

In some exemplary embodiments, Mobile Device 620 of User 650 may be placed on a surface that is parallel to the ground, such as a table, such that DoAs of voices in Environment 601 may be trackable by microphones of Mobile Device 620, of a device coupled to Mobile Device 620 such as Dongle 622, or the like. For example, an accelerometer embedded within Mobile Device 620 may sense whether or not Mobile Device 620 is parallel to the ground, and DoAs of voices may be determined to be tracked based thereon.

In some exemplary embodiments, microphones of Mobile Device 620 (or of a coupled device) may capture a noisy audio signal from Environment 601. In some exemplary embodiments, the noisy audio signal may comprise segments of Sounds 671, Sounds 673, Sounds 680, or the like. In some exemplary embodiments, the microphones may capture portions of Sounds 673 that reach Mobile Device 620 from Direction 675.

In some exemplary embodiments, Mobile Device 620 may process the noisy audio signal, such as according to Step 110 of FIG. 1. For example, Mobile Device 620 may apply speech separation on the noisy audio signal to extract Sounds 673 from Person 660, amplify the extracted sounds, track a DoA of different sounds, or the like. In some exemplary embodiments, Mobile Device 620 may generate two output audio signals for User 650: Signal 691 for Hearable 643 and Signal 693 for Hearable 641.

In some exemplary embodiments, in order to create an effect of directionality, in which User 650 perceives Signals 691 and 693 as reaching him from Direction 677 (although they technically reach User 650 from a direction of Mobile Device 620), a delay may be injected into Signal 691 and not into Signal 693. In some exemplary embodiments, the delay may create a directionality that corresponds to a directionality of sound waves from Direction 677. In other cases, a significant delay may be injected into Signal 691, and an insignificant delay may be injected into Signal 693.

In some exemplary embodiments, similar pairs of signals may be generated for any other entity in Environment 601, such as for Second Person 665. For example, a pair of signals representing a sound with directionality of Second Person 665 may be generated by Mobile Device 620, by any other separate device, by Hearables 641 and 643, or the like. In some exemplary embodiments, a post-processing stage may be implemented by Hearables 641 and 643, or by any other device, such as in order to combine different pairs of signals into a single pair of audio channels, one for each hearable. For example, the pair of audio channels may incorporate a directionality of Person 660's voice and a directionality of Second Person 665's voice.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A method performed in an environment of a user, wherein a plurality of people is present in the environment, the user having at least one hearable device used for providing audio output to the user, the method comprising:
capturing, by two or more microphones of at least one separate device physically separate from the at least one hearable device, a noisy audio signal from the environment of the user;
processing the noisy audio signal, thereby obtaining an enhanced audio signal, said processing comprises applying speech separation on the noisy audio signal to obtain a separate speech segment of a person of the plurality of people, wherein the speech separation utilizes an acoustic fingerprint of the person for extracting the separate speech segment of the person; and
outputting the enhanced audio signal to the user via the at least one hearable device.

2. The method of claim 1, wherein the two or more microphones of the at least one separate device comprise an array of three microphones, wherein the three microphones are positioned as vertices of a substantially equilateral triangle, whereby a distance between any two microphones of the three microphones is substantially identical.

3. The method of claim 2, wherein the distance is above a minimal threshold.

4. The method of claim 1, wherein the two or more microphones of the at least one separate device comprise an array of three microphones, wherein the three microphones are positioned as vertices of a substantial isosceles triangle, whereby a distance between a first microphone and each of a second and third microphones is substantially identical.

5. The method of claim 1, wherein the two or more microphones of the at least one separate device comprise an array of at least three microphones, wherein the at least three microphones maintain a line of sight with each other.

6. The method of claim 1, wherein the two or more microphones of the at least one separate device comprise an array of at least four microphones, wherein the at least four microphones are positioned in two or more planes, thereby enabling to obtain three degrees of freedom.

7. The method of claim 1, wherein one or more second microphones of the at least one hearable device are configured to capture a second noisy audio signal from the environment of the user, the second noisy audio signal at least partially corresponding to the noisy audio signal, wherein, using the second noisy audio signal, the at least one hearable device can operate to process and output audio irrespective of a connectivity between the at least one hearable device and the at least one separate device, whereby operation of the at least one hearable device is enhanced when having the connectivity with the at least one separate device, but is not dependent thereon.

8. The method of claim 1, wherein said processing the noisy audio signal is performed, at least partially, at the at least one separate device.

9. The method of claim 8 further comprising communicating the enhanced audio signal from the at least one separate device to the at least one hearable device, wherein said communicating is performed prior to said outputting.

10. The method of claim 1, wherein the at least one separate device comprises at least one of: a case of the at least one hearable device, a dongle that is configured to be coupled to a mobile device of the user, and the mobile device of the user.

11. The method of claim 10, wherein the two or more microphones are positioned on the dongle.

12. The method of claim 10, wherein the at least one separate device comprises at least two separate devices selected from: the case, the dongle, and the mobile device of the user, wherein said processing comprises communicating captured audio signals between the at least two separate devices.

13. The method of claim 10, wherein the at least one separate device comprises the case, the dongle, and the mobile device, wherein the case, the dongle, and the mobile device comprise respective sets of one or more microphones, wherein said processing comprises communicating audio signals captured by the respective sets of one or more microphones between the case, the dongle, and the mobile device.

14. The method of claim 1, wherein said processing is performed partially on at least one separate device, and partially on the at least one hearable device.

15. The method of claim 14 further comprising selecting how to distribute said processing between the at least one hearable device and the at least one separate device.

16. The method of claim 15, wherein said selecting is performed automatically based on at least one of: user instructions, a complexity of a conversation of the user in the environment, and a selected setting.

17. The method of claim 15, wherein the at least hearable device is operatively coupled, directly or indirectly, to a mobile device, wherein said selecting comprising selecting how to distribute the processing between the at least one hearable device and the mobile device.

18. A system comprising:
at least one hearable device used for providing audio output to a user; and
at least one separate device that is physically separate from the at least one hearable device, the at least one separate device comprising two or more microphones, wherein the at least one separate device is configured to perform:
capturing, by the two or more microphones of the at least one separate device, a noisy audio signal from an environment of the user, wherein a plurality of people is located in the environment;
processing the noisy audio signal, thereby obtaining an enhanced audio signal, said processing comprises applying speech separation on the noisy audio signal to obtain a separate speech segment of a person of the plurality of people, wherein the speech separation utilizes an acoustic fingerprint of the person for extracting the separate speech segment of the person; and
communicating the separate speech segment to the at least one hearable device, whereby enabling the at least one hearable device to output the enhanced audio signal to the user.

19. The system of claim 18, wherein the two or more microphones of the at least one separate device comprise an array of three microphones, wherein the three microphones are positioned as vertices of a substantially equilateral triangle, whereby a distance between any two microphones of the three microphones is substantially identical.

20. The system of claim 18, wherein the two or more microphones of the at least one separate device comprise an array of at least three microphones, wherein the at least three microphones maintain a line of sight with each other.

21-92. (canceled)
